(19) United States
(12) Patent Application Publication
(10) Pub. No.: US 2009/0137449 A1
(43) Pub. Date: May 28, 2009

(54) WASHING OR CLEANING AGENT

(76) Inventor: Thomas HOLDERBAUM, Hilden (DE)

Correspondence Address: PAUL & PAUL, 2000 MARKET STREET, Suite 2900, PHILADELPHIA, PA, 19103-3229, US

(21) Appl. No.: 11/876,158

(22) Filed: Oct. 22, 2007

Related U.S. Application Data
(63) Continuation of application No. PCT/EP2006/002936, filed on Mar. 31, 2006.

(30) Foreign Application Priority Data
Apr. 22, 2005 (DE) 10 2005 018 925.3

(51) Int. Cl. C11D 17/00

(52) U.S. Cl. 510/446; 510/535

(57) ABSTRACT

Washing- or cleaning-agent shaped elements made of a compressed particulate material, wherein the compressed particulate material encompasses a particulate surfactant granulate having a concentration of nonionic surfactants above 50 wt %, and at least 70 wt % of the particles of said surfactant granulate have a particle size below 1,250 μm, are notable for increased transport and shelf stability, improved cleaning and rinsing performance, and an improved tablet appearance.

### CROSS-REFERENCE TO RELATED APPLICATIONS

This application is a continuation under 35 U.S.C. § 365(c) and 35 U.S.C. § 120 of International Application No. PCT/EP2006/002936, filed Mar. 31, 2006. This application also claims priority under 35 U.S.C. § 119 of German Application No. DE 10 2005 018 925.3, filed Apr. 22, 2005.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

The present invention is in the field of washing or cleaning agents, in particular, of dispensed units for washing or cleaning agents.

Washing or cleaning agents are obtainable by consumers today in a wide variety of presentation forms. In addition to washing powders and granulates, these forms also encompass, for example, cleaning-agent concentrates in the form of extruded or tableted compositions. These solid, concentrated, or compressed presentation forms are notable for a reduced volume per dispensed unit, and therefore decrease costs for packaging and transport. The washing- or cleaning-agent tablets, in particular, additionally meet the consumer's desire for simple dispensing. The corresponding agents are comprehensively described in the existing art. In addition to the advantages set forth, however, compacted washing or cleaning agents also exhibit a number of disadvantages. Because they are highly compressed, tableted presentation forms, in particular, are often notable for delayed breakdown and therefore delayed release of their ingredients. To resolve this “conflict” between sufficient tablet hardness and short breakdown times, numerous technical solutions have been disclosed in the patent literature; reference may be made at this juncture, by way of example, to the use of tablet bursting agents. These breakdown accelerators are added to the tablets in addition to the substances having washing or cleaning activity; the accelerators themselves usually have no properties related to washing or cleaning activity, and therefore increase the complexity and cost of these agents. A further disadvantage when tableting active substance mixtures, in particular, mixtures containing substances having washing or cleaning activity, is inactivation of the active-substance contents by the compacting pressure that occurs upon tableting. Inactivation of the active substances can also occur by chemical reaction caused by the increased contact surfaces of the ingredients resulting from tableting.

Despite an extensive existing art in the field of washing- or cleaning-agent shaped elements, a great deal of opportunity still exists for improving both the chemical and the physical properties of this specific presentation form, focusing in particular, on transport and shelf stability as well as washing or cleaning performance.

### BRIEF SUMMARY OF THE INVENTION

It was therefore the object of the present invention to make available washing- or cleaning-agent shaped elements that, as compared with conventional agents, are notable for improved cleaning performance and additionally for improved transport and shelf stability, the disadvantages of compression or compaction nevertheless being avoided to the greatest extent possible. This object was achieved by washing- or cleaning-agent shaped elements that contain a finely particulate, surfactant-rich granulate.

A first subject of the present invention is therefore a washing- or cleaning-agent shaped element made of a compressed particulate material, wherein the compressed particulate material encompasses a particulate surfactant granulate having a concentration of nonionic surfactants above 50 wt %, wherein at least 70 wt % of the particles of said surfactant granulate have a particle size below 1,250 μm.

A further subject of the present invention is a surfactant granulate having a concentration of nonionic surfactants above 50 wt %, wherein at least 70 wt % of the particles of the surfactant granulate have a particle size below 1,250 μm.

### BRIEF DESCRIPTION OF THE SEVERAL VIEWS OF THE DRAWING(S)

Not Applicable

### DETAILED DESCRIPTION OF THE INVENTION

The washing- or cleaning-agent shaped elements according to the present invention are obtained by compressing a particulate material. The compressing or compacting methods preferred in this context are, in particular, extrusion, pelleting, roller compacting, and in particular, tableting.

The production of washing- or cleaning-agent tablets is performed in the manner known to one skilled in the art by compressing particulate starting substances. For production of the tablets, the premix is compacted in a mold between two dies, yielding a solid compressed body. This operation, which will be referred to hereinafter for brevity's sake as “tableting,” is subdivided into four portions: metering, compaction (elastic deformation), plastic deformation, and ejection. Tableting is by preference performed on rotary presses.

In the context of tableting with rotary presses, it has proven advantageous to perform tableting with the smallest possible fluctuations in tablet weight. This also allows fluctuations in tablet hardness to be reduced. Small weight fluctuations can be achieved in the following fashion:

use of plastic inserts having small thickness tolerances

low rotor rotation speed

large filling shoes

coordination between filling shoe blade speed and rotor rotation speed

constant powder height in the filling shoe

decoupling of filling shoe and powder supply.

All anti-adhesion coatings known in the art are suitable for reducing die caking. Plastic coatings, plastic inserts, or plastic dies are particularly advantageous. Rotating dies have also proven advantageous, and if possible the upper and lower dies should be configured to be capable of rotating. A plastic insert can usually be dispensed with in the case of rotating dies. In this case the die surfaces should be electro-polished.

Washing- or cleaning-agent shaped elements preferred in the context of the present invention are obtained by compression at pressing forces from 0.01 to 50 kNcm⁻², by preference, 0.1 to 40 kNcm⁻², and in particular, 1 to 25 kNcm⁻².

The washing- or cleaning-agent shaped elements contain a granulate with high surfactant concentration. Surfactant granulates having a nonionic surfactant concentration above 60 wt % have proven particularly advantageous in their cleaning and rinsing effect, and in terms of the shelf stability of the shaped elements and the color stability of colored shaped elements or shaped-element phases.

A preferred subject of the present invention is therefore a washing- or cleaning-agent shaped element wherein the particulate surfactant granulate has a nonionic surfactant concentration above 60 wt %, by preference, above 70 wt %, preferably, above 80 wt %, and in particular, above 90 wt %.

A further preferred subject is surfactant granulates, wherein the surfactant granulate has a nonionic surfactant concentration above 60 wt %, by preference, above 70 wt %, preferably, above 80 wt %, and in particular, above 90 wt %.

Several nonionic surfactants used with particular preference in the context of the present invention are set forth below.

Suitable as nonionic surfactants, for example, are alkyl glycosides of the general formula RO(G)ₓ, in which R corresponds to a primary straight-chain or methyl-branched (in particular, methyl-branched in the 2-position) aliphatic radical having 8 to 22, by preference, 12 to 18 C atoms; and G is the symbol denoting a glycose unit having 5 or 6 C atoms, preferably glucose. The degree of oligomerization x, which indicates the distribution of monoglycosides and oligoglycosides, is any number between 1 and 10; by preference, x is between 1.2 and 1.4.

A further class of nonionic surfactants used in preferred fashion, which are used either as the only nonionic surfactant or in combination with other nonionic surfactants, is alkoxylated, preferably, ethoxylated or ethoxylated and propoxylated, fatty acid alkyl esters, by preference, having 1 to 4 carbon atoms in the alkyl chain.

Nonionic surfactants of the amine oxide type, for example, N-cocalkyl-N,N-dimethylamine oxide and N-tallowalkyl-N,N-dihydroxyethylamine oxide, and the fatty acid alkanolamides, can also be suitable. The quantity of these nonionic surfactants is by preference no more than that of the ethoxylated fatty alcohols, in particular, no more than half thereof.

Further suitable surfactants are polyhydroxy fatty acid amides of the formula

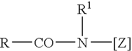

in which R denotes an aliphatic acyl radical having 6 to 22 carbon atoms; R¹ denotes hydrogen, an alkyl or hydroxyalkyl radical having 1 to 4 carbon atoms; and [Z] denotes a linear or branched polyhydroxyalkyl radical having 3 to 10 carbon atoms and 3 to 10 hydroxyl groups. The polyhydroxy fatty acid amides are known substances that can usually be obtained by reductive amination of a reducing sugar with ammonia, an alkylamine, or an alkanolamine, and subsequent acylation with a fatty acid, a fatty acid alkyl ester, or a fatty acid chloride.

Also belonging to the group of the polyhydroxy fatty acid amides are compounds of the formula

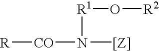

in which R denotes a linear or branched alkyl or alkenyl radical having 7 to 12 carbon atoms; R¹ denotes a linear, branched, or cyclic alkyl radical or an aryl radical having 2 to 8 carbon atoms; and R² denotes a linear, branched, or cyclic alkyl radical or an aryl radical or an oxyalkyl radical having 1 to 8 carbon atoms, C₁₋₄ alkyl or phenyl radicals being preferred; and [Z] denotes a linear polyhydroxyalkyl radical whose alkyl chain is substituted with at least two hydroxyl groups, or alkoxylated, preferably ethoxylated or propoxylated, derivatives of that radical.

[Z] is preferably obtained by reductive amination of a reducing sugar, for example, glucose, fructose, maltose, lactose, galactose, mannose, or xylose. The N-alkoxy- or N-aryloxy-substituted compounds can be converted into the desired polyhydroxy fatty acid amides by reaction with fatty acid methyl esters in the presence of an alkoxide as catalyst.

Low-foaming nonionic surfactants are used as particularly preferred surfactants. Particularly preferably, the surfactant granulates in the washing- or cleaning-agent shaped elements, in particular, cleaning-agent shaped elements for automatic dishwashing, contain nonionic surfactants from the group of the alkoxylated alcohols. The nonionic surfactants used are preferably alkoxylated, advantageously ethoxylated, in particular, primary alcohols having by preference 8 to 18 C atoms and an average of 1 to 12 mol ethylene oxide (EO) per mol of alcohol, in which the alcohol radical can be linear or preferably methyl-branched in the 2-position, or can contain mixed linear and methyl-branched radicals, such as those that are usually present in oxo alcohol radicals. Particularly preferred, however, are alcohol ethoxylates having linear radicals made up of alcohols of natural origin having 12 to 18 C atoms, from coconut, palm, tallow, or oleyl alcohol, and an average of 2 to 8 EO per mol of alcohol. The preferred ethoxylated alcohols include, for example, C₁₂₋₁₄ alcohols with 3 EO or 4 EO, C₉₋₁₁ alcohols with 7 EO, C₁₃₋₁₅ alcohols with 3 EO, 5 EO, 7 EO, or 8 EO, C₁₂₋₁₈ alcohols with 3 EO, 5 EO, or 7 EO, and mixtures thereof, such as mixtures of C₁₂₋₁₄ alcohol with 3 EO and C₁₂₋₁₈ alcohol with 5 EO. The degrees of ethoxylation indicated represent statistical averages, which can correspond to an integral or a fractional number for a specific product. Preferred alcohol ethoxylates exhibit a narrow distribution of homologs (narrow range ethoxylates, NRE). In addition to these nonionic surfactants, fatty alcohols with more than 12 EO can also be used. Examples of these are tallow fatty alcohol with 14 EO, 25 EO, 30 EO, or 40 EO.

It is, therefore, particularly preferred to use ethoxylated nonionic surfactants that were obtained from C₆₋₂₀ monohydroxyalkanols or C₆₋₂₀ alkylphenols or C₁₆₋₂₀ fatty alcohols and more than 12 mol, by preference more than 15 mol, and in particular, more than 20 mol ethylene oxide per mol of alcohol. A particularly preferred nonionic surfactant is obtained from a straight-chain fatty alcohol having 16 to 20 carbon atoms (C₁₆₋₂₀ alcohol), by preference, a C₁₈ alcohol, and at least 12 mol, by preference, at least 15 mol, and in particular, at least 20 mol ethylene oxide. Among these, the “narrow range ethoxylates” are particularly preferred.

It is furthermore particularly preferred to use surfactants that contain one or more tallow fatty alcohols with 20 to 30 EO in combination with a silicone defoamer.

Nonionic surfactants that have a melting point above room temperature are particularly preferred. (A) nonionic surfactant(s) having a melting point above 20° C., by preference, above 25° C., particularly preferably, between 25 and 60° C., and in particular, between 26.6 and 43.3° C., is/are particularly preferred.

Suitable nonionic surfactants that have melting or softening points in the aforesaid temperature range are, for example, low-foaming nonionic surfactants that can be solid or highly viscous at room temperature. When nonionic surfactants that are highly viscous at room temperature are used, it is then preferred that they have a viscosity above 20 Pa·s, by preference, above 35 Pa·s, and in particular, above 40 Pa·s. Nonionic surfactants that possess a waxy consistency at room temperature are also preferred.

Nonionic surfactants from the group of the alkoxylated alcohols, particularly preferably, from the group of the mixed alkoxylated alcohols, and in particular, from the group of the EO-AO-EO nonionic surfactants, are likewise used with particular preference.

The nonionic surfactant that is solid at room temperature preferably additionally possesses propylene oxide units in the molecule. Such PO units preferably constitute up to 25 wt %, particularly preferably, up to 20 wt %, and in particular, up to 15 wt % of the total molar weight of the nonionic surfactant. Particularly preferred nonionic surfactants are ethoxylated monohydroxyalkanols or alkylphenols that additionally comprise polyoxyethylene-polyoxypropylene block copolymer units. The alcohol or alkylphenol portion of such nonionic surfactant molecules preferably constitutes more than 30 wt %, particularly preferably, more than 50 wt %, and in particular, more than 70 wt % of the total molar weight of such nonionic surfactants. Preferred agents are characterized in that they contain ethoxylated and propoxylated nonionic surfactants in which the propylene oxide units in the molecule constitute up to 25 wt %, preferably, up to 20 wt %, and in particular, up to 15 wt % of the total molar weight of the nonionic surfactant.

Nonionic surfactants that are preferred for use derive from the groups of the alkoxylated nonionic surfactants, in particular, the ethoxylated primary alcohols, and mixtures of these surfactants with structurally more-complex surfactants such as polyoxypropylene/polyoxyethylene/polyoxypropylene (PO/EO/PO) surfactants. Such (PO/EO/PO) nonionic surfactants are moreover characterized by good foaming control.

Additional nonionic surfactants having melting points above room temperature that are particularly preferred for use contain 40 to 70% of a polyoxypropylene/polyoxyethylene/polyoxypropylene block polymer blend, which contains 75 wt % of a reverse block copolymer of polyoxyethylene and polyoxypropylene having 17 mol ethylene oxide and 44 mol propylene oxide, and 25 w % of a block copolymer of polyoxyethylene and polyoxypropylene, initiated with trimethylol propane and containing 24 mol ethylene oxide and 99 mol propylene oxide per mol of trimethylol propane.

Low-foaming nonionic surfactants that comprise alternating ethylene oxide and alkylene oxide units have proven to be particularly preferred nonionic surfactants in the context of the present invention. Among these in turn, surfactants having EO-AO-EO-AO blocks are preferred, one to ten EO groups or AO groups being bound to one another in each case before being followed by a block of the respectively other groups. Preferred here are nonionic surfactants of the general formula

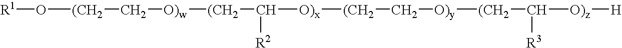

in which R¹ denotes a straight-chain or branched, saturated, or mono- or polyunsaturated C₆₋₂₄ alkyl or alkenyl radical; each R² and R³ group is selected, mutually independently, from —CH₃, —CH₂CH₃, —CH₂CH₂—CH₃, CH(CH₃)₂; and the indices w, x, y, and z denote, mutually independently, integers from 1 to 6.

The preferred nonionic surfactants of the above formula can be produced, using known methods, from the corresponding alcohols R¹—OH and ethylene oxide or alkylene oxide. The R¹ radical in the formula above can vary depending on the provenience of the alcohol. When natural sources are used, the R¹ radical has an even number of carbon atoms and is generally unbranched, the linear radicals from natural-origin alcohols having 12 to 18 C atoms, from coconut, palm, tallow, or oleyl alcohol, being preferred. Alcohols accessible from synthetic sources are, for example, the Guerbet alcohols or radicals methyl-branched in the 2-position, or mixed linear and methyl-branched radicals, such as those usually present in oxo alcohol radicals. Regardless of the type of alcohol used to produce the nonionic surfactants contained in the agents, nonionic surfactants in which R¹ in the above formula denotes an alkyl radical having 6 to 24, by preference, 8 to 20, particularly preferably, 9 to 15 and in particular, 9 to 11 carbon atoms are preferred.

In addition to propylene oxide, butylene oxide, in particular, is possible as the alkylene oxide unit that is contained, in an alternating sequence with the ethylene oxide unit, in the preferred nonionic surfactants. Also suitable, however, are further alkylene oxides in which R² and R³ are selected, mutually independently, from —CH₂CH₂—CH₃ and CH(CH₃)₂. It is preferred to use nonionic surfactants of the above formula in which R² and R³ denote a —CH₃ radical; w and x, mutually independently, denote values of 3 or 4; and y and z, mutually independently, denote values of 1 or 2.

In summary, nonionic surfactants that comprise a C₉₋₁₅ alkyl radical with 1 to 4 ethylene oxide units, followed by 1 to 4 propylene oxide units, followed by 1 to 4 ethylene oxide units, followed by 1 to 4 propylene oxide units, are particularly preferred. These surfactants exhibit the necessary low viscosity in aqueous solution, and are usable according to the present invention with particular preference.

Surfactants of the general formula

R¹—CH(OH)CH₂-(AO)_{w}(A′O)ₓ(A″O)_{y}(A′″O)_{z}—R²,

in which R¹ and R², mutually independently, denote a straight-chain or branched, saturated or mono- or polyunsaturated C₂₋₄₀ alkyl or alkenyl radical; A, A′, A″, and A′″, mutually independently, denote a radical from the group —CH₂CH₂, —CH₂CH₂—CH₂, —CH₂—CH(CH₃), —CH₂—CH₂—CH₂—CH₂, —CH₂—CH(CH₃)—CH₂—, —CH₂—CH(CH₂—CH₃); and w, x, y, and z denote values between 0.5 and 90, such that x, y, and/or z can also be 0, are preferred according to the present invention.

Particularly preferred are those end-capped poly(oxyalkylated) nonionic surfactants that, in accordance with the formula

R¹O[CH₂CH₂O]ₓCH₂CH(OH)R²,

in addition to an R¹ radical that denotes linear or branched, saturated or unsaturated, aliphatic or aromatic hydrocarbon radicals having 2 to 30 carbon atoms, preferably, having 4 to 22 carbon atoms, additionally comprise a linear or branched, saturated or unsaturated, aliphatic or aromatic hydrocarbon radical R² having 1 to 30 carbon atoms, x denoting values between 1 and 90, by preference, values between 40 and 80, and in particular, values between 40 and 80.

Particularly preferred are, in particular, nonionic surfactants of the general formula

R¹O[CH₂CH₂O]ₓCH₂CH(OH)R²

in which R¹ denotes a linear or branched alkyl and/or alkenyl radical having 4 to 22 carbon atoms, R² denotes a linear or branched alkyl and/or alkenyl radical having 2 to 22 carbon atoms, and x denotes 40 to 80.

A further preferred subject of the present invention is therefore a washing- or cleaning-agent shaped element made of a compressed particulate material, wherein the compressed particulate material is a particulate surfactant granulated having a concentration of nonionic surfactants of the general formula

R¹O[CH₂CH₂O]ₓCH₂CH(OH)R²

in which R¹ denotes a linear or branched alkyl and/or alkenyl radical having 4 to 22 carbon atoms, R² denotes a linear or branched alkyl and/or alkenyl radical having 2 to 22 carbon atoms, and x denotes values between 1 and 90, by preference values between 40 and 80, and in particular, values between 40 and 60, the concentration of the nonionic surfactant of the aforesaid general formula in the surfactant granulate being more than 50 wt %, and at least 70 wt % of the particles of said surfactant granulate having a particle size less than 1,250 μm.

In addition, particularly advantageously, nonionic surfactants of the general formula

R¹O[CH₂CH₂O]ₓCH₂CH(OH)R²

are used, in which R¹ denotes a linear or branched alkyl and/or alkenyl radical having 4 to 22 carbon atoms, R² denotes a linear or branched alkyl and/or alkenyl radical having 2 to 22 carbon atoms, and x denotes 10 to 30.

Washing- or cleaning-agent shaped elements wherein the compressed particulate material contains at least one nonionic surfactant of the general formula

R¹O[CH₂CH₂O]ₓCH₂CH(OH)R²,

in which R¹ denotes a linear or branched alkyl and/or alkenyl radical having 4 to 22 carbon atoms, R² denotes a linear or branched alkyl and/or alkenyl radical having 2 to 22 carbon atoms, and x denotes values from 10 to 30, are preferred according to the present invention.

With particular preference, the washing- or cleaning-agent shaped elements according to the present invention contain
a) a particulate surfactant granulate having a concentration of nonionic surfactants of the general formula R¹O[CH₂CH₂O]ₓCH₂CH(OH)R² in which R¹ denotes a linear or branched alkyl and/or alkenyl radical having 4 to 22 carbon atoms, R² denotes a linear or branched alkyl and/or alkenyl radical having 2 to 22 carbon atoms, and x denotes 40 and 80, the concentration of the nonionic surfactant of the aforesaid general formula in the surfactant granulate′ being more than 50 wt %, and at least 70 wt % of the particles of said surfactant granulate having a particle size less than 1,250 μm; and
b) nonionic surfactants of the general formula R¹O[CH₂CH₂O]ₓCH₂CH(OH)R² in which R¹ denotes a linear or branched alkyl and/or alkenyl radical having 4 to 22 carbon atoms, R² denotes a linear or branched alkyl and/or alkenyl radical having 2 to 22 carbon atoms, and x denotes 10 to 30.

The further nonionic surfactant of the general formula

R¹O[CH₂CH₂O]ₓCH₂CH(OH)R²

recited under b) can be both a constituent of the particulate surfactant granulate recited under a), but can also (and this variant is particularly preferred) be contained in a further surfactant granulate different from the one recited in a).

Particularly preferred are surfactants of the formula

R¹O[CH₂CH(CH₃)O]ₓ[CH₂CH₂O]_{y}CH₂CH(OH)R²

in which R¹ designates a linear or branched aliphatic hydrocarbon radical having 4 to 18 carbon atoms, or mixtures thereof; R² designates a linear or branched hydrocarbon radical having 2 to 26 carbon atoms or mixtures thereof; and x denotes values between 0.5 and 15, and y a value of at least 15.

Additionally particularly preferred are those end-capped poly(oxyalkylated) nonionic surfactants of the formula

R¹O[CH₂CH₂O]ₓ[CH₂CH(R³)O]_{y}CH₂CH(OH)R²

in which R¹ and R², mutually independently, denote a linear or branched, saturated or mono- or polyunsaturated hydrocarbon radical having 2 to 26 carbon atoms, R³ is selected, mutually independently, from —CH₃, —CH₂CH₃, —CH₂CH₂—CH₃, CH(CH₃)₂, but by preference denotes —CH₃, and x and y, mutually independently, denote values between 1 and 32, nonionic surfactants having R³=—CH₃ and values from 15 to 32 for x and from 0.5 to 1.5 for y being very particularly preferred.

Further nonionic surfactants that are preferred for use are the end-capped poly(oxyalkylated) nonionic surfactants of the formula

R¹O[CH₂CH(R³)O]ₓ[CH₂]ₖCH(OH)[CH₂]ⱼOR²

in which R¹ and R² denote linear or branched, saturated or unsaturated, aliphatic or aromatic hydrocarbon radicals having 1 to 30 carbon atoms; R³ denotes H or a methyl, ethyl, n-propyl, isopropyl, n-butyl, 2-butyl, or 2-methyl-2-butyl radical; x denotes values between 1 and 30; and k and j denote values between 1 and 12, by preference between 1 and 5. If the value of x is greater than or equal to 2, each R³ in the above formula R¹O[CH₂CH(R³)O]ₓ[CH₂]ₖCH(OH)[CH₂]ⱼOR² can be different. R¹ and R² are preferably linear or branched, saturated or unsaturated, aliphatic or aromatic hydrocarbon radicals having 6 to 22 carbon atoms, radicals having 8 to 18 C atoms being particularly preferred. For the R³ radical, H, —CH₃, or —CH₂CH₃ are particularly preferred. Particularly preferred values for x are in the range from 1 to 20, in particular, from 6 to 15.

As described above, each R³ in the formula above can be different if x≧2. The alkylene oxide unit in the square brackets can thereby be varied. If, for example, x denotes 3, the R³ radical can be selected so as to form ethylene oxide units (R³═H) or propylene oxide (R³═CH₃) units, which can be joined to one another in any sequence, for example, (EO)(PO)(EO), (EO)(EO)(PO), (EO)(EO)(EO), (PO)(EO)(PO), (PO)(PO)(EO), and (PO)(PO)(PO). The value of 3 for x was selected here as an example, and can certainly be larger; the range of variation increases with rising values of x, and includes, a large number of (EO) groups combined with a small number of (PO) groups, or vice versa.

Particularly preferred end-capped poly(oxyalkylated) alcohols of the above formula have values of k=1 and j=1, so that the formula above is simplified to

R¹O[CH₂CH(R³)O]ₓCH₂CH(OH)CH₂OR²

In the latter formula, R¹, R², and R³ are as defined above, and x denotes numbers from 1 to 30, by preference from 1 to 20, and in particular, from 6 to 18. Surfactants in which the R¹ and R² radicals have 9 to 14 C atoms, R³ denotes H, and x assumes values from 6 to 15, are particularly preferred.

The carbon chain lengths and degrees of ethoxylation or alkoxylation indicated for the aforesaid nonionic surfactants represent statistical averages that may be an integer or a fractional number for a specific product. As a result of production methods, commercial products of the aforesaid formulas are usually made up not of an individual representative, but rather of mixtures, so that average values and, as a consequence, fractional numbers, can result both for the carbon chain lengths and for the degrees of ethoxylation and alkoxylation.

The aforesaid nonionic surfactants can, of course, be used not only as individual substances, but also as surfactant mixtures of two, three, four, or more surfactants. “Surfactant mixtures” refers not to mixtures of nonionic surfactants that fall, in their totality, under one of the aforesaid general formulas, but instead to those mixtures containing two, three, four, or more nonionic surfactants that can be described by different ones of the aforesaid general formulas.

The concentration of particulate surfactant granulates in washing- or cleaning-agent shaped elements preferred according to the present invention is by preference, between 1 and 20 wt %, by preference, between 1 and 15 wt %, and in particular, between 1 and 10 wt %.

The concentration of nonionic surfactants in washing- or cleaning-agent shaped elements preferred according to the present invention is, by preference, between 1 and 12 wt %, by preference, between 1 and 10 wt %, particularly preferably, between 2 and 8 wt %, and in particular, between 2 and 6 wt %.

In addition to the concentration of nonionic surfactants, the particle size of the particles of the granulate having a high surfactant concentration, in particular, is of great importance in terms of the advantageous effect of the granulate, in particular, the improved cleaning and rinsing effect, and the improved shelf stability of the shaped element and the color stability of colored shaped elements or shaped-element phases; the advantages of the subject matter of the present invention increase as the weight proportion of particle sizes above 1,250 μm decreases.

For this reason, washing- or cleaning-agent shaped elements wherein at least 75 wt %, by preference, at least 80 wt %, preferably, at least 85 wt %, particularly preferably, at least 90 wt %, and in particular, at least 90 wt % of the particles of the surfactant granulate have a particle size below 1,250 μm, are particularly preferred.

Likewise preferred are corresponding surfactant granulates according to the present invention wherein at least 75 wt %, by preference, at least 80 wt %, preferably at least 85 wt %, particularly preferably, at least 90 wt %, and in particular, at least 90 wt % of the particles of the surfactant granulate have a particle size below 1,250 μm.

In addition to surfactant granulates having particle sizes above 1,250 μm, small-particle surfactant granulates having particle sizes below 100 μm have additionally proven disadvantageous in terms of the advantageous effect of the surfactant granulates according to the present invention.

Washing- or cleaning-agent shaped elements according to the present invention in which at least 60 wt %, preferably, at least 70 wt %, particularly preferably, at least 80 wt %, and in particular, at least 90 wt % of the particles of the surfactant granulate have a particle size between 100 μm and 1,250 μm are therefore particularly preferred.

For the aforesaid reasons, surfactant granulates according to the present invention wherein at least 60 wt % of the particles, preferably, at least 70 wt % of the particles, particularly preferably, at least 80 wt % of the particles, and in particular, at least 90 wt % of the particles of the surfactant granulate have a particle size between 100 μm and 1,250 μm, are likewise preferred.

The surfactant granulates according to the present invention by preference additionally contain a silicate material, finely particulate silicate materials such as amorphous and/or pyrogenic silica gels being particularly preferred. Dusting with finely particulate surface treatment agents can be advantageous in terms of the nature and physical properties of both the premix (storage, compression) and the finished washing- and cleaning-agent shaped elements. Finely particulate dusting agents are well known in the existing art, zeolites, silicates, or other inorganic salts usually being used. Preferably, however, the premix is “dusted” with finely particulate zeolite, zeolites of the faujasite type being preferred. In the context of the present invention, the term “zeolite of the faujasite type” characterizes all three zeolites that constitute the faujasite subgroup of zeolite structural group 4. In addition to zeolite X, zeolite Y and faujasite as well as mixtures of those compounds are usable, pure zeolite X being preferred.

Mixtures or co-crystals of zeolites of the faujasite type with other zeolites, which need not obligatorily belong to zeolite structural group 4, are also usable as dusting agents; it is advantageous if at least 50 wt % of the dusting agent is constituted by a zeolite of the faujasite type.

Preferred in the context of the present invention are washing- and cleaning-agent shaped elements that are made of a particulate premix that contains granular components and subsequently mixed-in powdered substances. The powdered component(s) subsequently mixed in being a zeolite of the faujasite type having particle sizes below 100 μm, preferably, below 10 μm, and in particular, below 5 μm, and constituting at least 0.2 wt %, by preference, at least 0.5 wt %, and in particular, more than 1 wt % of the premix to be compacted. Preferred washing- and cleaning-agent shaped elements are characterized in that the surfactant granulate contains 0.2 to 4 wt %, by preference 1 to 3 wt %, of a silicate material.

Also additionally preferred, therefore, are surfactant granulates wherein the surfactant granulate contains 0.2 to 4 wt %, by preference, 1 to 3 wt %, of a silicate material.

Surfactant granulates according to the present invention are notable, as compared with conventional surfactant granulates, for easier dye acceptance, greater color intensity, and greater color homogeneity.

Preferred dyes, the selection of which will present no difficulty whatsoever to one skilled in the art, possess excellent shelf stability and insensitivity to the other ingredients of the agents and to light, and no pronounced substantivity with respect to the substrates to be treated with the dye-containing agents, for example, textiles, glass, ceramics, or plastic tableware, in order not to color them.

In the selection of coloring agents, care must be taken that the coloring agents exhibit good shelf stability and insensitivity to light, and do not exhibit too great an affinity for glass, ceramic, or plastic tableware. At the same time, it must also be considered when selecting suitable coloring agents that coloring agents have differing levels of stability with respect to oxidation. It is generally the case that water-insoluble coloring agents are more stable with respect to oxidation than water-soluble coloring agents. The concentration of the coloring agent in the washing or cleaning agents varies as a function of solubility and thus also of oxidation sensitivity. For readily water-soluble coloring agents, coloring-agent concentrations in the range of a few 10⁻² to 10⁻³ wt % are typically selected. In the case of the pigment dyes, on the other hand, which are particularly preferred because of their brilliance but are less readily water-soluble, the appropriate concentration of the coloring agent in the washing or cleaning agent is typically a few 10⁻³ to 10⁻⁴ wt %.

Coloring agents that can be destroyed oxidatively in the washing process, as well as mixtures thereof with suitable blue dyes, bluing agents, are preferred. It has proven advantageous to use coloring agents that are soluble in water or at room temperature in liquid organic substances. For example, anionic coloring agents such as anionic nitroso dyes are suitable.

Surfactant granulates according to the present invention that contain at least one dye, by preference, in quantities between 0.01 and 2 wt %, by preference, between 0.02 and 1 wt %, and in particular, between 0.05 and 0.5 wt %, are therefore preferred, as are washing- or cleaning-agent shaped elements according to the present invention wherein the compressed particulate material, by preference, the surfactant granulate, further contains at least one dye.

As described above, the washing- or cleaning-agent shaped elements are notable for improved shelf and transport stability, for improved cleaning and rinsing performance, and furthermore for an improved color effect, in particular, improved color brilliance and homogeneity.

Therefore, a further subject of the present invention is the use of a surfactant granulate according to the present invention for the manufacture of preferably colored washing- or cleaning-agent tablets.

Also claimed is the use of surfactant granulates according to the present invention to increase the stability of washing- or cleaning-agent shaped elements made of a compressed particulate material.

In addition to the ingredients described above, the surfactant granulates and/or washing- or cleaning-agent shaped elements according to the present invention can contain further substances having washing or cleaning activity. Substances having washing or cleaning activity from the group of the builders, surfactants, polymers, bleaching agents, enzymes, glass corrosion inhibitors, corrosion inhibitors, disintegration adjuvants, fragrances, and perfume carriers are used with particular preference in this context. These and further preferred ingredients are described below in further detail.

The builders include, in particular, the zeolites, silicates, carbonates, organic co-builders, and also (if there are no environmental prejudices against their use) the phosphates.

It is particularly preferable to use crystalline sheet-form silicates of the general formula NaMSiₓO₂ₓ₊₁.yH₂O, where M denotes sodium or hydrogen, x is a number from 1.9 to 22, by preference from 1.9 to 4, particularly preferred values for x being 2, 3, or 4, and y denotes a number from 0 to 33, by preference from 0 to 20. The crystalline sheet-form silicates of the formula NaMSiₓO₂ₓ₊₁.yH₂O are marketed, for example, by Clariant GmbH (Germany) under the trade name Na-SKS. Examples of these silicates are Na-SKS-1 (Na₂Si₂₂O₄₅.xH₂O, kenyaite), Na-SKS-2 (Na₂Si₁₄O₂₉.xH₂O, magadiite), Na-SKS-3 (Na₂Si₈O₁₇.xH₂O), or Na-SKS-4 (Na₂Si₄O₉.xH₂O, makatite).

Particularly suitable for the purposes of the present invention are crystalline sheet-form silicates of the formula NaMSiₓO₂ₓ₊₁.yH₂O in which x denotes 2. Particularly preferred are both β- and δ-sodium disilicates Na₂Si₂O₅.yH₂O as well as, especially, Na-SKS-5 (α-Na₂Si₂O₅), Na-SKS-7 (β-Na₂Si₂O₅, natrosilite), Na-SKS-9 (NaHSi₂O₅.H₂O), Na-SKS-10 (NaHSi₂O₅.3H₂O, kanemite), Na-SKS-11 (t-Na₂Si₂O₅), and Na-SKS-13 (NaHSi₂O₅), but in particular, Na-SKS-6 (δ-Na₂Si₂O₅).

Washing or cleaning agents by preference contain a weight proportion of the crystalline sheet-form silicate of the formula NaMSiₓO₂ₓ₊₁.yH₂O from 0.1 to 20 wt %, from 0.2 to 15 wt %, and in particular, from 0.4 to 10 wt %, based in each case on the total weight of said agents.

Also usable are amorphous sodium silicates having a Na₂O:SiO₂ modulus of 1:2 to 1:3.3, by preference, 1:2 to 1:2.8, and in particular, 1:2 to 1:2.6, which by preference are dissolution-delayed and exhibit secondary washing properties. The dissolution delay as compared with conventional amorphous sodium silicates may have been brought about in various ways, for example, by surface treatment, compounding, compacting/densification, or overdrying. In the context of this invention, the term “amorphous” is also understood to mean that in X-ray diffraction experiments, the silicates yield not the sharp X-ray reflections that are typical of crystalline substances, but at most one or more maxima in the scattered X radiation that have a width of several degree units of the diffraction angle.

Alternatively to or in combination with the aforesaid amorphous sodium silicates, X-amorphous silicates can be used whose silicate particles yield blurred or even sharp diffraction maxima in electron diffraction experiments. This is to be interpreted to mean that the products exhibit microcrystalline regions 10 to several hundred nm in size, values up to a maximum of 50 nm and, in particular, up to a maximum of 20 nm being preferred. Such X-ray amorphous silicates likewise exhibit a dissolution delay with respect to the conventional water glasses. Compacted amorphous silicates, compounded amorphous silicates, and overdried X-ray amorphous silicates are particularly preferred.

It is preferred in the context of the present invention that this/these silicate(s), by preference, alkali silicates, particularly preferably, crystalline or amorphous alkali disilicates, be contained in washing or cleaning agents in quantities from 3 to 60 wt %, by preference, 8 to 50 wt %, and in particular, 20 to 40 wt %, based in each case on the weight of the washing or cleaning agent.

Of course, the use of the generally known phosphates as builder substances is also possible, provided such use is not to be avoided for environmental reasons. Among the many commercially available phosphates, the alkali-metal phosphates, with particular preference, pentasodium or pentapotassium triphosphate (sodium or potassium tripolyphosphate), have the greatest significance in the washing and cleaning agent industry.

“Alkali-metal phosphates” is the summary designation for the alkali-metal (in particular, sodium and potassium) salts of the various phosphoric acids, in which context a distinction can be made between metaphosphoric acids (HPO₃)ₙ and orthophosphoric acid H₃PO₄, in addition to higher-molecular-weight representatives. The phosphates offer a combination of advantages: they act as alkali carriers, prevent lime deposits on machine parts and lime encrustations in fabrics, and furthermore contribute to cleaning performance.

Phosphates of particular technical importance are pentasodium triphosphate Na₅P₃O₁₀ (sodium tripolyphosphate) and the corresponding potassium salt pentapotassium triphosphate K₅P₃O₁₀ (potassium tripolyphosphate). The sodium potassium tripolyphosphates are additionally used in preferred fashion according to the present invention.

If phosphates are used in the context of the present Invention as substances having washing or cleaning activity in washing or cleaning agents, preferred agents then contains this/these phosphate(s), by preference alkali-metal phosphate(s), particularly preferably pentasodium or pentapotassium triphosphate (sodium or potassium tripolyphosphate) in quantities from 5 to 80 wt %, by preference, 15 to 75 wt %, and in particular, 20 to 70 wt %, based in each case on the weight of the washing or cleaning agent.

Additional detergency builders are the alkali carriers. Alkali carriers are considered to be, for example, alkali-metal hydroxides, alkali-metal carbonates, alkali-metal hydrogencarbonates, alkali-metal sesquicarbonates, the aforesaid alkali silicates, alkali metasilicates, and mixtures of the aforesaid substances, the alkali carbonates, in particular, sodium carbonate, sodium hydrogencarbonate, or sodium sesquicarbonate, being used in preferred fashion for purposes of this invention. A builder system containing a mixture of tripolyphosphate and sodium carbonate is particularly preferred. Likewise particularly preferred is a builder system containing a mixture of tripolyphosphate and sodium carbonate and sodium disilicate. Because of their low chemical compatibility with the other ingredients of washing or cleaning agents as compared with other builder substances, the alkali-metal hydroxides are preferably used only in small quantities, by preference, in quantities below 10 wt %, preferably, below 6 wt %, particularly preferably, below 4 wt %, and in particular, below 2 wt %, based in each case on the total weight of the washing or cleaning agent. Agents that contain, based on their total weight, less than 0.5 wt % and in particular, no alkali-metal hydroxides are particularly preferred.

The use of carbonate(s) and/or hydrogencarbonate(s) is particularly preferred, by preference, alkali carbonate(s), particularly preferably, sodium carbonate, in quantities from 2 to 50 wt %, by preference 5 to 40 wt %, and in particular, 7.5 to 30 wt %, based in each case on the weight of the washing or cleaning agent. Particularly preferred are agents that, based on the weight of the washing or cleaning agent, contain less than 20 wt %, by preference less than 17 wt %, preferably less than 13 wt %, and in particular, less than 9 wt % carbonate(s) and/or hydrogencarbonate(s), by preference, alkali carbonate(s), particularly preferably, sodium carbonate.

Organic co-builders that may be mentioned are, in particular, polycarboxylates/polycarboxylic acids, polymeric polycarboxylates, aspartic acid, polyacetals, dextrins, further organic co-builders (below), and phosphonates. These substance classes are described below.

Usable organic builder substances are, for example, the polycarboxylic acids usable in the form of their free acids and/or their sodium salts, “polycarboxylic acids” being understood as those carboxylic acids that carry more than one acid function. These are, for example, citric acid, adipic acid, succinic acid, glutaric acid, malic acid, tartaric acid, maleic acid, fumaric acid, sugar acids, aminocarboxylic acids, nitrilotriacetic acid (NTA), provided such use is not objectionable for environmental reasons, as well as mixtures thereof. The free acids typically also possess, in addition to their builder effect, the property of an acidifying component, and thus serve also to establish a lower and milder pH for washing or cleaning agents. Worthy of mention in this context are, in particular, citric acid, succinic acid, glutaric acid, adipic acid, gluconic acid, and any mixtures thereof.

Further suitable as builders are polymeric polycarboxylates; these are, for example, the alkali-metal salts of polyacrylic acid or polymethacrylic acid, for example, those having a relative molecular weight from 500 to 70,000 g/mol.

The molar weights indicated for polymeric polycarboxylates are, weight-averaged molar weights M_{w} of the respective acid form that were determined in principle by means of gel permeation chromatography (GPC), a UV detector having been used. The measurement was performed against an external polyacrylic acid standard that, because of its structural affinity with the polymers being investigated, yields realistic molecular weight values. These indications deviate considerably from the molecular weight indications in which polystyrenesulfonic acids are used as a standard. The molar weights measured against polystyrenesulfonic acids are usually much higher than the molar weights

Suitable polymers are, in particular, polyacrylates that preferably have a molecular weight from 2,000 to 20,000 g/mol. Because of their superior solubility, of this group the short-chain polyacrylates that have molar weights from 2,000 to 10,000 g/ml, and particularly preferably from 3,000 to 5,000 g/mol, may in turn be preferred.

Copolymeric polycarboxylates, in particular, those of acrylic acid with methacrylic acid and of acrylic acid or methacrylic acid with maleic acid, are also suitable. Copolymers of acrylic acid with maleic acid that contain 50 to 90 wt % acrylic acid and 50 to 10 wt % maleic acid have proven particularly suitable. Their relative molecular weight based on free acids is generally 2,000 to 70,000 g/mol, by preference 20,000 to 50,000 g/mol, and in particular, 30,000 to 40,000 g/mol.

The (co)polymeric polycarboxylates can be used either as a powder or as an aqueous solution. The (co)polymeric polycarboxylate concentration in washing or cleaning agents is by preference, 0.5 to 20 wt %, in particular, 3 to 10 wt %.

To improve water solubility, the polymers can also contain allylsulfonic acids such as, for example, allyloxybenzenesulfonic acid and methallylsulfonic acid, as monomers.

Also particularly preferred are biodegradable polymers made up of more than two different monomer units, for example, those that contain salts of acrylic acid and of maleic acid, as well as vinyl alcohol or vinyl alcohol derivatives, as monomers, or that contain salts of acrylic acid and of 2-alkylallylsulfonic acid, as well as sugar derivatives, as monomers.

Further preferred copolymers are those that have, as monomers, by preference, acrolein and acrylic acid/acrylic acid salts, or acrolein and vinyl acetate.

Also to be mentioned as further preferred builder substances are polymeric aminodicarboxylic acids, their salts or their precursor substances. Polyaspartic acids and their salts are particularly preferred.

Other suitable builder substances are polyacetals, which can be obtained by reacting dialdehydes with polyolcarboxylic acids that have 5 to 7 C atoms and at least 3 hydroxyl groups. Preferred polyacetals are obtained from dialdehydes such as glyoxal, glutaraldehyde, terephthalaldehyde, and mixtures thereof, and from polyolcarboxylic acids such as gluconic acid and/or glucoheptonic acid.

Other suitable organic builder substances are dextrins, for example, oligomers or polymers of carbohydrates, which can be obtained by partial hydrolysis of starches. The hydrolysis can be performed in accordance with usual methods, acid- or enzyme-catalyzed. These are by preference hydrolysis products having average molar weights in the range from 400 to 500,000 g/mol. A polysaccharide having a dextrose equivalent (DE) in the range from 0.5 to 40, in particular, from 2 to 30, is preferred, DE being a common indicator of the reducing effect of a polysaccharide as compared with dextrose, which possesses a DE of 100. Both maltodextrins having a DE between 3 and 20, and dry glucose syrups having a DE between 20 and 37 are usable, as well as yellow dextrins and white dextrins having higher molar weights in the range from 2,000 to 30,000 g/mol.

The oxidized derivatives of such dextrins are their reaction products with oxidizing agents that are capable of oxidizing at least one alcohol function of the saccharide ring to the carboxylic acid function.

Oxydisuccinates and other derivatives of disuccinates, by preference, ethylenediamine disuccinate, are also additional suitable co-builders. Ethylenediamine N,N′-disuccinate (EDDS) is preferably used here, in the form of its sodium or magnesium salts. Also preferred in this context are glycerol disuccinates and glycerol trisuccinates. Suitable utilization quantities in zeolite-containing and/or silicate-containing formulations are 3 to 15 wt %.

Other usable organic co-builders are, for example, acetylated hydroxycarboxylic acids and their salts, which can optionally also be present in lactone form and which contain at least 4 carbon atoms and at least one hydroxy group, as well as a maximum of two acid groups.

All compounds capable of forming complexes with alkaline earth ions can additionally be used as builders.

The group of the surfactants includes the nonionic, anionic, cationic, and amphoteric surfactants.

If the anionic surfactants are a constituent of automatic dishwashing agents, their concentration, based on the total weight of the agents, is by preference less than 4 wt %, preferably, less than 2 wt %, and very particularly, preferably less than 1 wt %. Automatic dishwashing agents that contain no anionic surfactants are particularly preferred.

Instead of the aforesaid surfactants or in combination with them, cationic and/or amphoteric surfactants can also be used.

Cationic compounds of the following formulas can be used, for example, as cationic active substances:

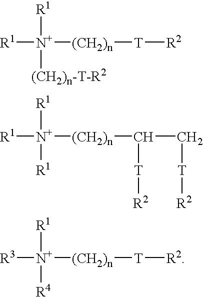

in which each R¹ group is selected, mutually independently, from C₁₋₆ alkyl, alkenyl, or hydroxyalkyl groups; each R² group is selected, mutually independently, from C₈₋₂₈ alkyl or alkenyl groups; R³═R¹ or (CH₂)ₙ-T-R²; R⁴═R¹ or R² or (CH₂)ₙ-T-R²; T=—CH₂—, —O—CO— or —CO—O,—and n is an integer from 0 to 5.

In automatic dishwashing agents, the concentration of cationic and/or amphoteric surfactants is by preference less than 6 wt %, preferably, less than 4 wt %, very particularly preferably, less than 2 wt %, and in particular, less than 1 wt %. Automatic dishwashing agents that contain no cationic or amphoteric surfactants are particularly preferred.

The group of the polymers includes, in particular, the polymers having washing or cleaning activity, for example, the clear rinsing polymers and/or polymers effective as softeners. In general, cationic, anionic, and amphoteric polymers can also be used alongside nonionic polymers in washing and cleaning agents.

“Cationic polymers” for purposes of the present invention are polymers that carry a positive charge in the polymer molecule. This can be implemented, for example, by way of (alkyl) ammonium groupings or other positively charged groups present in the polymer chain. Particularly preferred cationic polymers derive from the groups of the quaternized cellulose derivatives, the polysiloxanes having quaternary groups, the cationic guar derivatives, the polymeric dimethyldiallylammonium salts and their copolymers with esters and amides of acrylic acid and methacrylic acid, the copolymers of vinylpyrrolidone with quaternized derivatives of dialkylaminoacrylate and -methacrylate, the vinylpyrrolidone/methoimidazolinium chloride copolymers, the quaternized poly(vinylalcohols), or the polymers known by the INCI designations Polyquaternium 2, Polyquaternium 17, Polyquaternium 18, and Polyquaternium 27.

“Amphoteric polymers” for purposes of the present invention further comprise, in addition to a positively charged group in the polymer chain, negatively charged groups or monomer units. These groups can be, for example, carboxylic acids, sulfonic acids, or phosphonic acids.

Preferred washing or cleaning agents, in particular, preferred automatic dishwashing agents, are characterized in that they contain a polymer a) that comprises monomer units of the formula R¹R²C═CR³R⁴ in which each radical R¹, R², R³, R⁴ is selected, mutually independently, from hydrogen, a derivatized hydroxy group, C₁₋₃₀ linear or branched alkyl groups, aryl, aryl-substituted C₁₋₃₀ linear or branched alkyl groups, polyalkoxylated alkyl groups, heteroatomic organic groups having at least one positive charge without charged nitrogen, at least one quaternized N atom, or at least one amino group having a positive charge in the sub-range of the pH range from 2 to 11, or salts thereof, with the stipulation that at least one radical R¹, R², R³, R⁴ is a heteroatomic organic group having at least one positive charge without charged nitrogen, at least one quaternized N atom, or at least one amino group having a positive charge.

Cationic or amphoteric polymers that are particularly preferred in the context of the present invention contain as a monomer unit a compound of the general formula

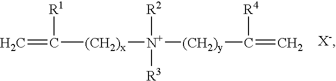

in which R¹ and R⁴, mutually independently, denote H or a linear or branched hydrocarbon radical having 1 to 6 carbon atoms; R² and R³, mutually independently, denote an alkyl, hydroxyalkyl, or aminoalkyl group in which the alkyl radical is linear or branched and comprises between 1 and 6 carbon atoms, this preferably being a methyl group; x and y, mutually independently, denote integers between 1 and 3. X⁻ represents a counterion, preferably a counterion from the group of chloride, bromide, iodide, sulfate, hydrogensulfate, methosulfate, lauryl sulfate, dodecylbenzenesulfonate, p-toluenesulfonate (tosylate), cumenesulfonate, xylenesulfonate, phosphate, citrate, formate, acetate, or mixtures thereof.

Preferred radicals R¹ and R⁴ in the above formula are selected from —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, and —(CH₂CH₂—O)ₙH.

Very particularly preferred are polymers that comprise a cationic monomer unit of the above general formula in which R¹ and R⁴ denote H, R² and R³ denote methyl, and x and y are each 1. The corresponding monomer units of the formula

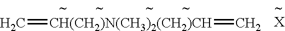

are also referred to, in the case in which X⁻=chloride, as DADMAC (diallyldimethylammonium chloride).

Further particularly preferred cationic or amphoteric polymers contain a monomer unit of the general formula

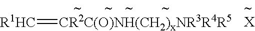

in which R¹, R², R³, R⁴ and R⁵, mutually independently, denote a linear or branched, saturated or unsaturated alkyl or hydroxyalkyl radical having 1 to 6 carbon atoms, preferably a linear or branched alkyl radical selected from —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, and —(CH₂CH₂—O)ₙH, and x denotes a whole number between 1 and 6.

Very particularly preferred in the context of the present Invention are polymers that comprise a cationic monomer unit of the above general formula in which R¹ denotes H and R², R³, R⁴, and R⁵ denote methyl, and x denotes 3. The corresponding monomer units of the formula

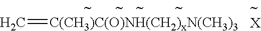

are also referred to, in the case where X=chloride, as MAPTAC (methacrylamidopropyltrimethylammonium chloride).

Polymers that contain, as monomer units, diallyldimethylammonium salts and/or acrylamidopropyltrimethylammonium salts are preferred according to the present invention.

The aforementioned amphoteric polymers comprise not only cationic groups but also anionic groups or monomer units. Anionic monomer units of this kind derive, for example, from the group of the linear or branched, saturated or unsaturated carboxylates, the linear or branched, saturated or unsaturated phosphonates, the linear or branched, saturated or unsaturated sulfates, or the linear or branched, saturated or unsaturated sulfonates. Preferred monomer units are acrylic acid, (meth)acrylic acid, (dimethyl)acrylic acid, (ethyl)acrylic acid, cyanoacrylic acid, vinylacetic acid, allylacetic acid, crotonic acid, maleic acid, fumaric acid, cinnamic acid, and their derivatives, the allylsulfonic acids such as, for example, allyloxybenzenesulfonic acid and methallylsulfonic acid, or the allylphosphonic acids.

Amphoteric polymers preferred for use derive from the group of the alkylacrylamide/acrylic acid copolymers, the alkylacrylamide/methacrylic acid copolymers, the alkylacrylamide/methylmethacrylic acid copolymers, the alkylacrylamide/acrylic acid/alkylaminoalkyl(meth)acrylic acid copolymers, the alkylacrylamide/methacrylic acid/alkylaminoalkyl(meth)acrylic acid copolymers, the alkylacrylamide/methylmethacrylic acid/alkylaminoalkyl(meth)acrylic acid copolymers, the alkylacrylamide/alkylmethacrylate/alkylaminoethylmethacrylate/alkylmethacrylate copolymers, and the copolymers of unsaturated carboxylic acids, cationically derivatized unsaturated carboxylic acids and, if applicable, further ionic or nonionogenic monomers.

Zwitterionic polymers preferred for use derive from the group of the acrylamidoalkyltrialkylammonium chloride/acrylic acid copolymers and their alkali and ammonium salts, the acrylamidoalkyltrialkylammonium chloride/methacrylic acid copolymers and their alkali and ammonium salts, and the methacroylethylbetaine/methacrylate copolymers.

Also preferred are amphoteric polymers that encompass, in addition to one or more anionic monomers, methacrylamidoalkyltrialkylammonium chloride and dimethyl(diallyl)ammonium chloride as cationic monomers.

Particularly preferred amphoteric polymers derive from the group of the methacrylamidoalkyltrialkylammonium chloride/dimethyl(diallyl)ammonium chloride/acrylic acid copolymers, the methacrylamidoalkyltrialkylammonium chloride/dimethyl(diallyl)ammonium chloride/methacrylic acid copolymers, and the methacrylamidoalkyltrialkylammonium chloride/dimethyl(diallyl)ammonium chloride/alkyl(meth)acrylic acid copolymers, as well as their alkali and ammonium salts.

Particularly preferred are amphoteric polymers from the group of the methacrylamidopropyltrimethylammonium chloride/dimethyl(diallyl)ammonium chloride/acrylic acid copolymers, the methacrylamidopropyltrimethylammonium chloride/dimethyl(diallyl)ammonium chloride/acrylic acid copolymers, and the methacrylamidopropyltrimethylammonium chloride/dimethyl(diallyl)ammonium chloride/alkyl(meth)acrylic acid copolymers, as well as their alkali and ammonium salts.

In a particularly preferred embodiment of the present invention, the polymers are present in prepackaged form. Suitable for packaging of the polymers are, among others:
encapsulation of the polymers by means of water-soluble or water-dispersible coating agents, preferably by means of water-soluble or water-dispersible natural or synthetic polymers;
encapsulation of the polymers by means of water-insoluble meltable coating agents, preferably by means of water-insoluble coating agents from the group of the waxes or paraffins having a melting point above 30° C.;
cogranulation of the polymers with inert carrier materials, by preference with carrier materials from the group of the substances having washing or cleaning activity, particularly preferably from the group of the builders or co-builders.

Washing or cleaning agents contain the aforesaid cationic and/or amphoteric polymers by preference in quantities between 0.01 and 10 wt %, based in each case on the total weight of the washing or cleaning agent. Those washing or cleaning agents are nevertheless preferred in the context of the present Invention in which the weight proportion of the cationic and/or amphoteric polymers is between 0.01 and 8 wt %, by preference, between 0.01 and 6 wt %, preferably, between 0.01 and 4 wt %, particularly preferably, between 0.01 and 2 wt %, and in particular, between 0.01 and 1 wt %, based in each case on the total weight of the automatic dishwashing agents.

Polymers effective as softeners are, for example, the sulfonic acid group-containing polymers, which are used with particular preference.

Particularly preferred for use as sulfonic acid group-containing polymers are copolymers of unsaturated carboxylic acids, sulfonic acid group-containing monomers, and if applicable further ionogenic or nonionogenic monomers.

Preferred as monomers in the context of the present invention are unsaturated carboxylic acids of the formula

R¹(R²)C═C(R³)COOH

in which R¹ to R³, mutually independently, denote —H—CH₃, a straight-chain or branched saturated alkyl radical having 2 to 12 carbon atoms, a straight-chain or branched, mono- or polyunsaturated alkenyl radical having 2 to 12 carbon atoms, alkyl or alkenyl radicals substituted with —NH₂, —OH, or —COOH, or denote —COOH or —COOR⁴, R⁴ being a saturated or unsaturated, straight-chain or branched hydrocarbon radical having 1 to 12 carbon atoms.

Among the unsaturated carboxylic acids that can be described by the above formula, acrylic acid (R¹═R²═R³═H), methacrylic acid (R¹═R²═H; R³═CH₃) and/or maleic acid (R¹═COOH; R²═R³═H) are particularly preferred.

Preferred in the context of the sulfonic acid group-containing monomers are those of the formula

R⁵(R⁶)C═C(R⁷)—X—SO₃H

in which R⁵ to R⁷, mutually independently, denote —H—CH₃, a straight-chain or branched saturated alkyl radical having 2 to 12 carbon atoms, a straight-chain or branched, mono- or polyunsaturated alkenyl radical having 2 to 12 carbon atoms, alkyl or alkenyl radicals substituted with —NH₂, —OH, or —COOH, or denote —COOH or —COOR⁴, R⁴ being a saturated or unsaturated, straight-chain or branched hydrocarbon radical having 1 to 12 carbon atoms, and X denotes an optionally present spacer group that is selected from —(CH₂)ₙ— where n=0 to 4, —COO—(CH₂)ₖ— where k=1 to 6, —C(O)—NH—C(CH₃)₂—, and —C(O)—NH—CH(CH₂CH₃)—.

Among these monomers, those of the formulas

H₂C═CH—X—SO₃H

H₂C═C(CH₃)—X—SO₃H

HO₃S—X—(R⁶)C═C(R⁷)—X—SO₃H

in which R⁶ and R⁷ are selected, mutually independently, from —H, —CH₃, —CH₂CH₃, —CH₂CH₂CH₃, —CH(CH₃)₂, and X denotes an optionally present spacer group that is selected from —(CH₂)ₙ— where n=0 to 4, —COO—(CH₂)ₖ— where k=1 to 6, —C(O)—NH—C(CH₃)₂—, and —C(O)—NH—CH(CH₂CH₃)—, are preferred.

Particularly preferred sulfonic acid group-containing monomers in this context are 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropylacrylate, 3-sulfopropylmethacrylate, sulfomethacrylamide, sulfomethylmethacrylamide, and water-soluble salts of the aforesaid acids.

Ethylenically unsaturated compounds, in particular, are suitable as further ionogenic or nonionogenic monomers. The concentration of these further ionogenic or nonionogenic monomers in the polymers that are used is by preference less than 20 wt %, based on the polymer. Polymers to be used in particularly preferred fashion are made up only of monomers of the formula

R¹(R²)C═C(R³)COOH

and monomers of the formula

R⁵(R⁶)C═C(R⁷)—X—SO₃H.

Additional particularly preferred copolymers are made up of
i) one or more unsaturated carboxylic acids from the group of acrylic acid, methacrylic acid, and/or maleic acid;
ii) one or more sulfonic acid group-containing monomers of the formulas:

H₂C═CH—X—SO₃H

H₂C═C(CH₃)—X—SO₃H

HO₃S—X—(R⁶)C═C(R⁷)—X—SO₃H
in which R⁶ and R⁷ are selected, mutually independently, from —H, —CH₃, —CH₂CH₃, —CH₂CH₂CH₃, —CH(CH₃)₂, and X denotes an optionally present spacer group that is selected from —(CH₂)ₙ— where n=0 to 4, —COO—(CH₂)ₖ— where k=1 to 6, —C(O)—NH—C(CH₃)₂—, and —C(O)—NH—CH(CH₂CH₃)—;
iii) if applicable, further ionogenic or nonionogenic monomers.

The copolymers can contain the monomers of groups i) and ii), and optionally iii), in varying quantities; all representatives of group i) can be combined with all representatives of group ii) and all representatives of group iii). Particularly preferred polymers comprise certain structural units that are described below.

Preferred, for example, are copolymers that contain structural units of the formula

—[CH₂—CHCOOH]ₘ—[CH₂—CHC(O)—Y—SO₃H]ₚ—,

in which m and p each denote a natural integer between 1 and 2,000, and Y denotes a spacer group that is selected from substituted or unsubstituted aliphatic, aromatic, or substituted aromatic hydrocarbon radicals having 1 to 24 carbon atoms, spacer groups in which Y denotes —O—(CH₂)ₙ— where n=0 to 4, —O—(C₆H₄)—, —NH—C(CH₃)₂—, or —NH—CH(CH₂CH₃)— being preferred.

These polymers are produced by copolymerization of acrylic acid with a sulfonic acid group-containing acrylic acid derivative. When the sulfonic acid group-containing acrylic acid derivative is copolymerized with methacrylic acid, a different polymer is arrived at, the use of which is likewise preferred. The corresponding copolymers which contain structural units of the formula

—[CH₂—C(CH₃)COOH]ₘ—[CH₂—CHC(O)—Y—SO₃H]ₚ—,

in which m and p each denote a natural integer between 1 and 2,000, and Y denotes a spacer group that is selected from substituted or unsubstituted aliphatic, aromatic, or substituted aromatic hydrocarbon radicals having 1 to 24 carbon atoms, spacer groups in which Y denotes —O—(CH₂)ₙ— where n=0 to 4, —O—(C₆H₄)—, —NH—C(CH₃)₂—, or —NH—CH(CH₂CH₃)— being preferred.

Entirely analogously, acrylic acid and/or methacrylic acid can also be copolymerized with sulfonic acid group-containing methacrylic acid derivatives, thereby modifying the structural units in the molecule. Copolymers that contain structural units of the formula

—[CH₂—CHCOOH]ₘ—[CH₂—C(CH₃)C(O)—Y—SO₃H]ₚ—,

in which m and p each denote a natural integer between 1 and 2,000, and Y denotes a spacer group that is selected from substituted or unsubstituted aliphatic, aromatic, or substituted aromatic hydrocarbon radicals having 1 to 24 carbon atoms, spacer groups in which Y denotes —O—(CH₂)ₙ— where n=0 to 4, —O—(C₆H₄)—, —NH—C(CH₃)₂—, or —NH—CH(CH₂CH₃)—, being preferred, are therefore preferred, as are copolymers that contain structural units of the formula

—[CH₂—C(CH₃)COOH]ₘ—[CH₂—C(CH₃)C(O)—Y—SO₃H]ₚ—,

in which m and p each denote a natural integer between 1 and 2,000, and Y denotes a spacer group that is selected from substituted or unsubstituted aliphatic, aromatic, or substituted aromatic hydrocarbon radicals having 1 to 24 carbon atoms, spacer groups in which Y denotes —O—(CH₂)ₙ— where n=0 to 4, —O—(C₆H₄)—, —NH—C(CH₃)₂—, or —NH—CH(CH₂CH₃)—, being preferred.

Instead of acrylic acid and/or methacrylic acid or as a supplement thereto, maleic acid can also be used as a particularly preferred monomer of group i). This results in copolymers preferred according to the present invention which contain structural units of the formula

—[HOOCCH—CHCOOH]ₘ—[CH₂—CHC(O)—Y—SO₃H]ₚ—,

in which m and p each denote a natural integer between 1 and 2,000, and Y denotes a spacer group that is selected from substituted or unsubstituted aliphatic, aromatic, or araliphatic hydrocarbon radicals having 1 to 24 carbon atoms, spacer groups in which Y denotes —O—(CH₂)ₙ— where n=0 to 4, —O—(C₆H₄)—, —NH—C(CH₃)₂—, or —NH—CH(CH₂CH₃)—, being preferred.

Additionally preferred according to the present invention are copolymers that contain structural units of the formula

—[HOOCCH—CHCOOH]ₘ—[CH₂—C(CH₃)C(O)O—Y—SO₃H]ₚ—,

in which m and p each denote a natural integer between 1 and 2,000, and Y denotes a spacer group that is selected from substituted or unsubstituted aliphatic, aromatic, or substituted aromatic hydrocarbon radicals having 1 to 24 carbon atoms, spacer groups in which Y denotes —O—(CH₂)ₙ— where n=0 to 4, —O—(C₆H₄)—, —NH—C(CH₃)₂—, or —NH—CH(CH₂CH₃)—, being preferred.

The sulfonic acid groups can be present in the polymers entirely or partially in neutralized form, the acid hydrogen atom of the sulfonic acid group can be exchanged, in some or all sulfonic acid groups, for metal ions, preferably alkali-metal ions, and in particular, sodium ions. The use of partially or entirely neutralized sulfonic acid group-containing copolymers is preferred according to the present invention.

The monomer distribution of the copolymers preferred for use according to the present invention is, in copolymers that contain only monomers from groups i) and ii), by preference, 5 to 95 wt % from each of i) and ii), particularly preferably, 50 to 90 wt % monomer from group i) and 10 to 50 wt % monomer from group ii), based in each case on the polymer.

For terpolymers, those that contain 20 to 85 wt % monomer from group i), 10 to 60 wt % monomer from group ii), and 5 to 30 wt % monomer from group iii), are particularly preferred.

The molar weight of the sulfo-copolymers preferred for use according to the present invention can be varied in order to adapt the properties of the polymers to the desired application. Preferred washing or cleaning agents are characterized in that the copolymers have molar weights from 2,000 to 200,000 gmol⁻¹, by preference, from 4,000 to 25,000 gmol⁻¹, and in particular, from 5,000 to 15,000 gmol⁻¹.

The bleaching agents are a substance having washing or cleaning activity that is used with particular preference. Among the compounds yielding H₂O₂ in water that serve as bleaching agents, sodium percarbonate, sodium perborate tetrahydrate, and sodium perborate monohydrate are of particular importance. Other usable bleaching agents are, for example, peroxypyrophosphates, citrate perhydrates, and peracid salts or peracids that yield H₂O₂, such as perbenzoates, peroxyphthalates, diperazelaic acid, phthaloimino peracid, or diperdodecanedioic acid.

Bleaching agents from the group of the organic bleaching agents can also be used. Typical organic bleaching agents are the diacyl peroxides such as, for example, dibenzoyl peroxide. Further typical organic bleaching agents are the peroxy acids, the alkylperoxy acids and arylperoxy acids being mentioned in particular, as examples. Preferred representatives are (a) peroxybenzoic acid and its ring-substituted derivatives, such as alkylperoxybenzoic acids, but peroxy-α-naphthoic acid and magnesium monoperphthalate, (b) the aliphatic or substituted aliphatic peroxy acids, such as peroxylauric acid, peroxystearic acid, ε-phthalimidoperoxycaproic acid [phthaloiminoperoxyhexanoic acid (PAP)], o-carboxybenzamidoperoxycaproic acid, N-nonenylamidoperadipic acid, and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyl-di(6-aminopercaproic) acid, can also be used.

Substances that release chlorine or bromine can also be used as bleaching agents. Among the suitable materials releasing chlorine or bromine are, for example, heterocyclic N-bromamides and N-chloramides, for example, trichloroisocyanuric acid, tribromoisocyanuric acid, dibromoisocyanuric acid, and/or dichloroisocyanuric acid (DICA) and/or their salts with cations such as potassium and sodium. Hydantoin compounds such as 1,3-dichloro-5,5-dimethylhydantoin are also suitable.

Washing or cleaning agents that contain 1 to 35 wt %, by preference 2.5 to 30 wt %, particularly preferably, 3.5 to 20 wt %, and in particular, 5 to 15 wt % bleaching agent, by preference, sodium percarbonate, are preferred according to the present invention.

The active oxygen concentration of the washing or cleaning agents, in particular, of the automatic dishwashing agents, is by preference between 0.4 and 10 wt %, particularly preferably, 0.5 and 8 wt %, and in particular, between 0.6 and 5 wt %, based in each case on the total weight of the agent. Particularly preferred agents have an active oxygen concentration above 0.3 wt %, preferably above 0.7 wt %, particularly preferably, above 0.8 wt %, and in particular, above 1.0 wt %.

Bleach activators are used in washing or cleaning agents, for example, in order to achieve an improved bleaching effect when cleaning at temperatures of 60° C. and below. Compounds that, under perhydrolysis conditions, yield aliphatic peroxycarboxylic acids having preferably 1 to 10 carbon atoms, in particular, 2 to 4 C atoms, and/or optionally substituted perbenzoic acid, can be used as bleach activators. Substances that carry O- and/or N-acyl groups having the aforesaid number of carbon atoms, and/or optionally substituted benzoyl groups, are suitable. Multiply acylated alkylenediamines, in particular, tetraacetylethylenediamine (TAED), acylated triazine derivatives, in particular, 1,5-diacetyl-2,4-dioxohexahydro-1,3,5-triazine (DADHT), acylated glycolurils, in particular, tetraacetyl glycoluril (TAGU), N-acylimides, in particular, N-nonanoyl succinimide (NOSI), acylated phenolsulfonates, in particular, n-nonanoyl or isononanoyl oxybenzenesulfonate (n- and iso-NOBS), carboxylic acid anhydrides, in particular, phthalic acid anhydride, acylated polyvalent alcohols, in particular, triacetin, ethylene glycol diacetate, and 2,5-diacetoxy-2,5-dihydrofuran, are preferred.

Further bleach activators preferred for use in the context of the present invention are compounds from the group of the cationic nitriles, in particular, cationic nitriles of the formula

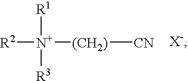

in which R¹ denotes —H, —CH₃, a C₂₋₂₄ alkyl or alkenyl radical, a substituted C₂₋₂₄ alkyl or alkenyl radical having at least one substituent from the group of —Cl, —Br, —OH, —NH₂, —CN, an alkyl or alkenylaryl radical having a C₁₋₂₄ alkyl group, or denotes a substituted alkyl or alkenylaryl radical having a C₁₋₂₄ alkyl group and at least one further substituent on the aromatic ring; R² and R³ are selected, mutually independently, from —CH₂—CN, —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, —(CH₂CH₂—O)ₙH, where n=1, 2, 3, 4, 5 or 6; and X is an anion, by preference from the group of chloride, bromide, iodide, hydrogensulfate, methosulfate, p-toluenesulfonate (tosylate), or xylenesulfonate.

Particularly preferred are compounds of the formulas (CH₃)₃N⁽⁺⁾CH₂—CN X⁻, (CH₃CH₂)₃N⁽⁺⁾CH₂—CN X⁻, (CH₃CH₂CH₂)₃N⁽⁺⁾CH₂—CN X⁻, (CH₃CH(CH₃) )₃N⁽⁺⁾CH₂—CN X⁻, or (HO—CH₂—CH₂)₃N⁽⁺⁾CH₂—CN X⁻ are particularly preferred; of the group of these substances, the cationic nitrile of the formula (CH₃)₃N⁽⁺⁾CH₂—CN X⁻, in which X⁻ denotes an anion that is selected from the group of chloride, bromide, iodide, hydrogensulfate, methosulfate, p-toluenesulfonate (tosylate), or xylenesulfonate, is in turn particularly preferred.

Compounds that, under perhydrolysis conditions, yield aliphatic peroxycarboxylic acids having preferably, 1 to 10 C atoms, in particular, 2 to 4 C atoms, and/or optionally substituted perbenzoic acid, can additionally be used as bleach activators. Substances that carry O- and/or N-acyl groups having the aforesaid number of C atoms, and/or optionally substituted benzoyl groups, are suitable. Multiply acylated alkylenediamines, in particular, tetraacetylethylendiamine (TAED), acylated triazine derivatives, in particular, 1,5-diacetyl-2,4-dioxohexahydro-1,3,5-triazine (DADHT), acylated glycolurils, in particular, tetraacetyl glycoluril (TAGU), N-acylimides, in particular, N-nonanoylsuccinimide (NOSI), acylated phenolsulfonates, in particular, n-nonanoyl or isononanoyl oxybenzenesulfonate (n- or iso-NOBS), carboxylic acid anhydrides, in particular, phthalic acid anhydrides, acylated polyvalent alcohols, in particular, triacetin, ethylene glycol diacetate, 2,5-diacetoxy-2,5-dihydrofuran, n-methylmorpholinium acetonitrile methyl sulfate (MMA), as well as acetylated sorbitol and mannitol and mixtures thereof (SORMAN), acylated sugar derivatives, in particular, pentaacetylglucose (PAG), pentaacetylfructose, tetraacetylxylose and octaacetyllactose, as well as acetylated, optionally N-alkylated glucamine and gluconolactone, and/or N-acylated lactams, for example, N-benzoylcaprolactam, are preferred. Hydrophilically substituted acyl acetates and acyl lactams are likewise used in preferred fashion. Combinations of conventional bleach activators can also be used.

If further bleach activators in addition to the nitrilquats are to be used, the bleach activators used are preferably those from the group of the multiply acylated alkylenediamines, in particular, tetraacetylethylendiamine (TAED), N-acylimides, in particular, N-nonanoylsuccinimide (NOSI), acylated phenolsulfonates, in particular, n-nonanoyl or isononanoyl oxybenzenesulfonate (n- or iso-NOBS), n-methylmorpholinium acetonitrile methyl sulfate (MMA), by preference, in quantities up to 10 wt %, in particular, 0.1 wt % to 8 wt %, particularly, 2 to 8 wt %, and particularly preferably, 2 to 6 wt %, based on the total weight of the dispersion.

In addition to or instead of the conventional bleach activators, bleach catalysts can also be used. These substances are bleach-intensifying transition-metal salts or transition-metal complexes such as, for example, Mn, Fe, Co, Ru, or Mo salt complexes or carbonyl complexes. Mn, Fe, Co, Ru, Mo, Ti, V, and Cu complexes having nitrogen-containing tripod ligands, as well as Co, Fe, Cu, and Ru ammine complexes, are also applicable as bleach catalysts.

Bleach-intensifying transition-metal complexes, in particular, having the central atoms Mn, Fe, Co, Cu, Mo, V, Ti, and/or Ru, preferably, selected from the group of the manganese and/or cobalt salts and/or complexes, particularly preferably, the cobalt(ammine) complexes, the cobalt(acetate) complexes, the cobalt(carbonyl) complexes, the chlorides of cobalt or manganese, and manganese sulfate, are used in usual quantities, by preference, in a quantity up to 5 wt %, in particular, from 0.0025 wt % to 1 wt %, and particularly preferably, from 0.01 wt % to 0.25 wt %, based in each case on the total weight of the bleach activator-containing agent. Even more bleach activator can, however, be used in specific cases.

Enzymes are usable in order to enhance the washing or cleaning performance of washing or cleaning agents, respectively. These include, in particular, proteases, amylases, lipases, hemicellulases, cellulases, or oxidoreductases, as well as preferably mixtures thereof. These enzymes are, in principle, of natural origin; improved variants based on the natural molecules are available for use in washing and cleaning agents and are correspondingly preferred for use. Washing or cleaning agents contain enzymes, by preference, in total quantities from 1×10⁻⁶ to 5 wt %, based on active protein. The protein concentration can be determined with known methods, for example, the BCA method or the biuret method.

Among the proteases, those of the subtilisin type are preferred. Examples thereof are the subtilisins BPN′ and Carlsberg and their further-developed forms, protease PB92, subtilisins 147 and 309, the alkaline protease from, subtilisin DY, and the enzymes (to be classified, however, as subtilases rather than as subtilisins in the strict sense) thermitase, proteinase K, and proteases TW3 and TW7.

Examples of amylases usable according to the present invention are the α-amylases from , , , and, and the further developments of the aforesaid amylases improved for use in washing and cleaning agents. Additionally to be highlighted for this purpose are the α-amylase from A 7-7 (DSM 12368) and the cyclodextrin-glucanotransferase (CGTase) from (DSM 9948).

Additionally usable according to the present invention are lipases or cutinases, in particular, because of their triglyceride-cleaving activities but also in order to generate peracids from suitable precursors. These include, for example, the lipases obtainable originally from ( ) or further-developed lipases, in particular, those having the D96L amino acid exchange. Also usable, for example, are the cutinases that were originally isolated from and. Also usable are lipases and cutinases whose starting enzymes were originally isolated from and.

It is also possible to use enzymes that are grouped under the term “hemicellulases.” These include, for example, mannanases, xanthanlyases, pectinlyases (=pectinases), pectinesterases, pectatelyases, xyloglucanases (=xylanases), pullulanases, and β-glucanases.

To enhance the bleaching effect, according to the present invention oxidoreductases, for example, oxidases, oxygenases, catalases, peroxidases such as halo-, chloro-, bromo-, lignin, glucose, or manganese peroxidases, dioxygenases, or laccases (phenoloxidases, polyphenoloxidases) can be used. Advantageously, preferably organic, particularly preferably aromatic compounds that interact with the enzymes are additionally added in order to enhance the activity of the relevant oxidoreductases (enhancers) or, if there is a large difference in redox potentials between the oxidizing enzymes and the dirt particles, to ensure electron flow (mediators).

The enzymes can be used in any form established according to the existing art. These include, for example, the solid preparations obtained by granulation, extrusion, or lyophilization or, especially in the case of liquid or gelled agents, solutions of the enzymes, advantageously as concentrated as possible, anhydrous, and/or with stabilizers added.

Alternatively, the enzymes can be encapsulated for both the solid and the liquid administration form, for example, by spray-drying or extrusion of the enzyme solution together with a preferably natural polymer, or in the form of capsules, for example, ones in which the enzymes are enclosed, in a solidified gel, or in those of the core-shell type, in which an enzyme-containing core is covered with a protective layer impermeable to water, air, and/or chemicals. Further active substances, for example stabilizers, emulsifiers, pigments, bleaching agents, or dyes, can additionally be applied in superimposed layers. Such capsules are applied in accordance with methods known, for example by vibratory or rolling granulation or in fluidized bed processes. Such granulates are advantageously low in dust, as a result of the application of polymeric film-forming agents, and are stable in storage due to the coating.

It is additionally possible to package two or more enzymes together, so that a single granulate exhibits several enzyme activities.

A protein and/or enzyme can be protected, especially during storage, from damage such as, for example, inactivation, denaturing, or decomposition, resulting from physical influences, oxidation, or proteolytic cleavage. An inhibition of proteolysis is particularly preferred in the context of microbial recovery of the proteins and/or enzymes, in particular, when the agents also contain proteases. Washing or cleaning agents can contain stabilizers for this purpose; the provision of such agents represents a preferred embodiment of the present invention.

Preferably one or more enzymes and/or enzyme preparations, by preference solid protease preparations and/or amylase preparations, are used, in quantities from 0.1 to 5 wt %, by preference, from 0.2 to 4.5 wt %, and in particular, from 0.4 to 4 wt %, based in each case on the entire enzyme-containing agent.

Glass corrosion inhibitors prevent the occurrence of clouding, smearing, and scratches, but also iridescence, of the glass surface of automatically washed glassware. Preferred glass corrosion inhibitors derive from the group of the magnesium and/or zinc salts and/or magnesium and/or zinc complexes.

The spectrum of zinc salts, by preference of organic acids, particularly preferably, of organic carboxylic acids, that are preferred according to the present invention extends from salts that are poorly soluble or insoluble in water, exhibit a solubility below 100 mg/l, preferably below 10 mg/l, in particular, below 0.01 mg/l, to those salts that exhibit a solubility in water above 100 mg/l, by preference, above 500 mg/l, particularly preferably above 1 g/l, and in particular, above 5 g/l (all solubilities at a water temperature of 20° C.). Zinc citrate, zinc oleate, and zinc stearate, for example, belong to the first group of zinc salts; zinc formate, zinc acetate, zinc lactate, and zinc gluconate, for example, belong to the group of the soluble zinc salts.

At least one zinc salt of an organic carboxylic acid, particularly preferably a zinc salt from the group of zinc stearate, zinc oleate, zinc gluconate, zinc acetate, zinc lactate, and/or zinc citrate, is used with particular preference as a glass corrosion inhibitor. Zinc ricinoleate, zinc abietate, and zinc oxalate are also preferred.

In the context of the present invention, the zinc salt concentration of cleaning agents is by preference between 0.1 and 5 wt %, preferably, between 0.2 and 4 wt %, and in particular, between 0.4 and 3 wt %, or the concentration of zinc in oxidized form (calculated as Zn²⁺) is between 0.01 and 1 wt %, by preference, between 0.02 and 0.5 wt %, and in particular, between 0.04 and 0.2 wt %, based in each case on the total weight of the glass corrosion inhibitor-containing agent.

Corrosion inhibitors serve to protect the items being washed or the machine, silver protection agents having particular importance in the automatic dishwashing sector. The known substances of the existing art are usable. In general, silver protection agents can be selected principally from the group of the triazoles, benzotriazoles, bisbenzotriazoles, aminotriazoles, alkylaminotriazoles, and transition-metal salts or complexes. It is particularly preferred to use benzotriazole and/or alkylaminotriazole. It is preferred according to the present invention to use 3-amino-5-alkyl-1,2,4-triazoles or their physiologically acceptable salts, these substances being used with particular preference at a concentration from 0.001 to 10 wt %, preferably, 0.0025 to 2 wt %, particularly preferably, 0.01 to 0.04 wt %. Preferred acids for salt formation are hydrochloric acid, sulfuric acid, phosphoric acid, carbonic acid, sulfurous acid, organic carboxylic acids such as acetic, glycolic, citric, succinic acid. 5-pentyl, 5-heptyl, 5-nonyl, 5-undecyl, 5-isononyl, 5-versatic-10 acid alkyl-3-amino-1,2,4-triazoles, and mixtures of these substances, are very particularly effective.

Cleaner formulations moreover often comprise active-chlorine-containing agents that can greatly decrease the corrosion of silver surfaces. In chlorine-free cleaners, oxygen- and nitrogen-containing organic redox-active compounds are used, in particular, such as di- and trivalent phenols, hydroquinone, catechol, hydroxyhydroquinone, gallic acid, phloroglucine, pyrogallol, and derivatives of these classes of compounds. Salt-like and complex-like inorganic compounds, such as salts of the metals Mn, Ti, Zr, Hf, V, Co, and Ce, are also often used. Preferred in this context are the transition-metal salts that are selected from the group of the manganese and/or cobalt salts and/or complexes, particularly preferably the cobalt(ammine) complexes, cobalt(acetate) complexes, cobalt(carbonyl) complexes, the chlorides of cobalt or manganese, and manganese sulfate. Zinc compounds can also be used to prevent corrosion on the items being washed.

Instead of, or in addition to, the silver protection agents described above, for example, the benzotriazoles, redox-active substances can be used in the dispersions according to the present invention. These substances are by preference inorganic redox-active substances from the group of the manganese, titanium, zirconium, hafnium, vanadium, cobalt, and cerium salts and/or complexes, the metals by preference being present in one of the oxidation stages II, III, IV, V, or VI.

The metal salts or metal complexes that are used should be at least partially soluble in water. The counterions suitable for salt formation comprise all usual singly, doubly, or triply negatively charged inorganic anions, oxide, sulfate, nitrate, fluoride, but also organic anions such as, for example, stearate.

Particularly preferred metal salts and/or metal complexes are selected from the group of MnSO₄, Mn(II) citrate, Mn(II) stearate, Mn(II) acetyl acetonate, Mn(II)-[1-hydroxyethane-1,1-diphosphonate], V₂O₅, V₂O₄, VO₂, TiOSO₄, K₂TiF₆, K₂ZrF₆, CoSO₄, Co(NO₃)₂, Ce(NO₃)₃ and mixtures thereof, so that the metal salts and/or metal complexes selected from the group of MnSO₄, Mn(II) citrate, Mn(II) stearate, Mn(II) acetyl acetonate, Mn(II) [1-hydroxyethane-1,1-diphosphonate], V₂O₅, V₂O₄, VO₂, TiOSO₄, K₂TiF₆, K₂ZrF₆, CoSO₄, Co(NO₃)₂, Ce(NO₃)₃ are used with particular preference.

The inorganic redox-active substances, in particular, metal salts or metal complexes, are preferably coated, completely covered with a material that is watertight but easily soluble at cleaning temperatures, in order to prevent their premature decomposition or oxidation during storage. Preferred coating materials, which are applied using known methods, Sandwik melt-coating methods from the food industry, are paraffins, microcrystalline waxes, waxes of natural origin such as carnauba wax, candelilla wax, beeswax, higher-melting-point alcohols such as, for example, hexadecanol, soaps, or fatty acids.

The aforesaid metal salts and/or metal complexes are contained in cleaning agents, by preference, in a quantity from 0.05 to 6 wt %, by preference, 0.2 to 2.5 wt %, based in each case on the entire agent.

In order to facilitate the breakdown of prefabricated shaped elements, it is possible to incorporate disintegration adjuvants, tablet bursting agents, into these agents in order to shorten breakdown times. Tablet bursting agents or breakdown accelerators are understood as adjuvants that ensure the rapid breakdown of tablets in water or gastric juice, and the release of drugs in resorbable form.

These substances, which because of their action are also referred to as “bursting” agents, increase in volume upon the entry of water; on the one hand, their own volume is increased (swelling), and on the other hand, the release of gases can also generate a pressure that allows the tablets to break down into smaller particles. Familiar disintegration adjuvants are, for example, carbonate/citric acid systems; other organic acids can also be used. Swelling disintegration adjuvants are, for example, synthetic polymers such as polyvinylpyrrolidone (PVP), or natural polymers or modified natural substances such as cellulose and starch and their derivates, alginates, or casein derivatives.

Disintegration adjuvants are preferably used in quantities from 0.5 to 10 wt %, by preference, 3 to 7 wt %, and in particular, 4 to 6 wt %, based in each case on the total weight of the disintegration adjuvant-containing agent.

Cellulose-based disintegration agents are used as preferred disintegration agents, so that preferred washing and cleaning agents contain such a cellulose-based disintegration agent in quantities from 0.5 to 10 wt %, by preference, 3 to 7 wt %, and in particular, 4 to 6 wt %. Pure cellulose has the formal gross composition (C₆H₁₀O₅)ₙ, and in formal terms constitutes a β-1,4-polyacetal of cellobiose, which in turn is made up of two molecules of glucose. Suitable celluloses are made up of approximately 500 to 5,000 glucose units, and consequently have average molar weights of 50,000 to 500,000. Also usable in the context of the present invention as cellulose-based disintegration agents are cellulose derivatives that are obtainable from cellulose via polymer-analogous reactions. Such chemically modified celluloses encompass, for example, products of esterification or etherification processes in which hydroxy hydrogen atoms were substituted. Celluloses in which the hydroxy groups were replaced with functional groups that are not bound via an oxygen atom can also, however, be used as cellulose derivatives. The group of the cellulose derivatives embraces, for example, alkali celluloses, carboxymethyl cellulose (CMC), cellulose esters and ethers, and aminocelluloses. The aforesaid cellulose derivatives are preferably used not as the only cellulose-based disintegration agent, but in a mixture with cellulose. The cellulose-derivative concentration of these mixtures is by preference below 50 wt %, particularly preferably, below 20 wt %, based on the cellulose-based disintegration agent. Pure cellulose that is free of cellulose derivatives is particularly preferred for use as a cellulose-based disintegration agent.

The cellulose used as a disintegration adjuvant is preferably not used in finely divided form, but instead is converted into a coarser form, for example, granulated or compacted, before being mixed into the premixtures that are to be compressed. The particle sizes of such disintegration agents are usually above 200 μm, by preference, at least 90 wt % between 300 and 1,600 μm, and in particular, at least 90 wt % between 400 and 1,200 μm.

Microcrystalline cellulose can be used as a further cellulose-based disintegration agent or as a constituent of that component. This microcrystalline cellulose is obtained by partial hydrolysis of celluloses under conditions such that only the amorphous regions (approximately 30% of the total cellulose mass) of the celluloses are attacked and dissolve completely, but the crystalline regions (approximately 70%) remain undamaged. A subsequent disaggregation of the microfine celluloses produced by hydrolysis yields the microcrystalline celluloses, which have primary particle sizes of approximately 5 μm and are compactable, for example, into granules having an average particle size of 200 μm.

Preferred disintegration adjuvants, by preference, a cellulose-based disintegration adjuvant, by preference, in granular, co-granulated, or compacted form, are contained in the disintegration adjuvant-containing agents in quantities from 0.5 to 10 wt %, by preference from 3 to 7 wt %, and, in particular, from 4 to 6 wt %, based in each case on the total weight of the disintegration adjuvant-containing agent.

Gas-evolving effervescence systems can be used, in a manner preferred according to the present invention, as tablet disintegration adjuvants. The gas-evolving effervescence system can be made up of a single substance that releases a gas upon contact with water. To be mentioned among these compounds is, in particular, magnesium peroxide, which releases oxygen upon contact with water. Usually, however, the gas-releasing bubbling system is in turn made up of at least two constituents that react with one another to form gas. While a plurality of systems that release, for example, nitrogen, oxygen, or hydrogen, are conceivable and implementable here, the bubbling system used in the washing and cleaning agents will be selected with regard to both economic and environmental considerations. Preferred effervescence systems are made up of alkali-metal carbonate and/or hydrogencarbonate as well as an acidifying agent that is suitable for releasing carbon dioxide from the alkali-metal salts in aqueous solution.

Boric acid, as well as alkali-metal hydrogensulfates, alkali-metal dihydrogenphosphates, and other inorganic salts are usable, for example, as acidifying agents that release carbon dioxide from the alkali salts in aqueous solution. Organic acidifying agents are preferably used, however, citric acid being a particularly preferred acidifying agent. Acidifying agents in the effervescence system from the group of the organic di-, tri- and oligocarboxylic acids, or mixtures, are preferred.

Individual odorant compounds, the synthetic products of the ester, ether, aldehyde, ketone, alcohol, and hydrocarbon types, can be used as perfume oils or fragrances in the context of the present invention. Preferably, however, mixtures of different odorants that together produce an attractive fragrance note are used. Such perfume oils can also contain natural odorant mixtures such as those accessible from plant sources, for example pine, citrus, jasmine, patchouli, rose, or ylang-ylang oil.

In order to be perceptible, an odorant must be volatile; in addition to the nature of the functional groups and the structure of the chemical compound, the molecular weight also plays an important part. Most odorants, for example, possess molar weights of up to approximately 200 dalton, while molar weights of 300 dalton and above represent something of an exception. Because of the differing volatility of odorants, the odor of a perfume or fragrance made up of multiple odorants changes during volatilization, the odor impressions being subdivided into a “top note,” “middle note” or “body,” and “end note” or “dry out.” Because the perception of an odor also depends a great deal on the odor intensity, the top note of a perfume or fragrance is not made up only of highly volatile compounds, while the end note comprises for the most part less-volatile, adherent odorants. In the compounding of perfumes, more-volatile odorants can, for example, be bound to specific fixatives, thereby preventing them from volatilizing too quickly. In the division below of odorants into “more-volatile” and “adherent” odorants, therefore, no statement is made regarding the odor impression, or as to whether the corresponding odorant is perceived as a top or middle note.

The fragrances can be processed directly, but it may also be advantageous to apply the fragrances onto carriers that ensure a slower fragrance release for longer-lasting fragrance. Cyclodextrins, for example, have proven successful as carrier materials of this kind; the cyclodextrin-perfume complexes can additionally be coated with further adjuvants.

The dyes have already been exhaustively described above. To avoid repetition, reference is made at this juncture to those statements.

In addition to the components previously described in detail, the washing and cleaning agents can contain further ingredients that further improve the engineering and/or aesthetic properties of those agents. Preferred agents contain one or more substances from the group of the electrolytes, pH adjusting agents, fluorescent agents, hydrotopes, foam inhibitors, silicone oils, anti-redeposition agents, optical brighteners, graying inhibitors, shrinkage preventers, wrinkle protection agents, color transfer inhibitors, antimicrobial ingredients, germicides, fungicides, antioxidants, antistatic agents, ironing adjuvants, proofing and impregnating agents, swelling and anti-slip agents, and UV absorbers.

A large number of very varied salts from the group of the inorganic salts can be used as electrolytes. Preferred cations are the alkali and alkaline earth metals. Preferred anions are the halides and sulfates. In terms of production engineering, the use of NaCl or MgCl₂ in the washing and cleaning agents is preferred.

In order to bring the pH of washing or cleaning agents into the desired range, the use of pH adjusting agents may be indicated. All known acids and bases are usable here, provided their use is not prohibited for environmental or engineering reasons, or for reasons of consumer safety. The quantity of these adjusting agents usually does not exceed 1 wt % of the entire formulation.

Appropriate foam inhibitors are, among others, soaps, oils, fats, paraffins, or silicone oils, which optionally can be applied onto carrier materials. Suitable carrier materials are, for example, inorganic salts such as carbonates or sulfates, cellulose derivatives, or silicates, as well as mixtures of the aforesaid materials. Agents preferred in the context of the present Invention contain paraffins, by preference, unbranched paraffins (n-paraffins), and/or silicones, preferably, linear polymeric silicones, which are constructed according to the (R₂SiO)ₓ pattern and are also referred to as silicone oils. These silicone oils usually represent clear, colorless, neutral, odorless, hydrophobic liquids having a molecular weight between 1,000 and 150,000 and viscosities between 10 and 1,000,000 mPa·s.

Suitable anti-redeposition agents, which are also referred to as soil repellents, are, for example, nonionic cellulose ethers such as methyl cellulose and methylhydroxypropyl cellulose having a 15 to 30 wt % proportion of methoxy groups and a 1 to 15 wt % proportion of hydroxypropyl groups, based on the nonionic cellulose ethers in each case, as well as polymers, known from the existing art, of phthalic acid and/or terephthalic acid and of their derivatives, in particular, polymers of ethylene terephthalates and/or polyethylene glycol terephthalates or anionically and/or nonionically modified derivatives thereof. Of these, the sulfonated derivates of phthalic acid polymers and terephthalic acid polymers are particularly preferred.

Optical brighteners (“whiteners”) can be added to the washing or cleaning agents in order to eliminate graying and yellowing of the treated textiles. These substances are absorbed onto the fibers and cause a brightening and simulated bleaching effect by converting invisible ultraviolet radiation into visible longer-wave light; the ultraviolet light absorbed from sunlight is radiated as a weakly bluish fluorescence, combining with the yellow tint of the grayed or yellowed laundry to yield pure white. Suitable compounds derive, for example, from the substance classes of the 4,4′-diamino-2,2′-stilbenedisulfonic acids (flavonic acids), 4,4′-distyrylbiphenylene, methylumbelliferones, cumarins, dihydroquinolinones, 1,3-diarylpyrazolines, naphthalic acid imides, benzoxazole, benzisoxazole, and benzimidazole systems, and the pyrene derivatives substituted with heterocycles.

The purpose of graying inhibitors is to keep dirt released from the fibers suspended in the bath, thus preventing the dirt from redepositing. Water-soluble colloids, usually organic in nature, are suitable for this, for example, the water-soluble salts of polymeric carboxylic acids, size, gelatin, salts of ethersulfonic acids of starch or cellulose, or salts of acid sulfuric acid esters of cellulose or starch. Water-soluble polyamides containing acid groups are also suitable for this purpose. Soluble starch preparations, and starch products other than those mentioned above, degraded starch, aldehyde starches, can also be used. Polyvinylpyrrolidone is also usable. Also usable as graying inhibitors are cellulose ethers such as carboxymethyl cellulose (Na salt), methyl cellulose, hydroxyalkyl cellulose, and mixed ethers such as methylhydroxyethyl cellulose, methylhydroxypropyl cellulose, methylcarboxymethyl cellulose, and mixtures thereof.

Because textile fabrics, in particular, those made of rayon, viscose, cotton, and mixtures thereof, can tend to wrinkle because the individual fibers are sensitive to bending, kinking, compression, and squeezing transversely to the fiber direction, synthetic wrinkle-prevention agents can be used. These include, for example, synthetic products based on fatty acids, fatty acid esters, fatty acid amides, fatty acid alkylol esters, fatty acid alkylolamides, or fatty alcohols that are usually reacted with ethylene oxide, or products based on lecithin or modified phosphoric acid esters.

The purpose of proofing and impregnation methods is to finish textiles with substances that prevent the deposition of dirt or make it easier to wash out. Preferred proofing and impregnation agents are perfluorinated fatty acids, including in the form of their aluminum and zirconium salts, organic silicates, silicones, polyacrylic acid esters having perfluorinated alcohol components, or polymerizable compounds coupled to a perfluorinated acyl or sulfonyl radical. Antistatic agents can also be present. Dirt-repelling finishing with proofing and impregnation agents is often categorized as an “easy-care” finish. Penetration of the impregnation agents, in the form of solutions or emulsions of the relevant active substances, can be facilitated by the addition of wetting agents that reduce surface tension. A further area of use of proofing and impregnation agents is water-repellent finishing of textile materials, tents, awnings, leather, in which, in contrast to waterproofing, the fabric pores are not sealed, the material is still able to “breathe” (hydrophobizing). The hydrophobizing agents used for hydrophobizing cover the textiles, leather, paper, wood, with a very thin layer of hydrophobic groups such as longer alkyl chains or siloxane groups. Suitable hydrophobizing agents are, for example, paraffins, waxes, metal soaps, having added portions of aluminum or zirconium salts, quaternary ammonium compounds with long-chain alkyl radicals, urea derivatives, fatty acid-modified melamine resins, chromium-complex salts, silicones, organo-tin compounds, and glutaric dialdehyde, as well as perfluorinated compounds. The hydrophobized materials are not oily to the touch, but water droplets bead up on them (similarly to oiled fabrics) without wetting them. Silicone-impregnated textiles, for example, have a soft hand and are water- and dirt-repellent; drops of ink, wine, fruit juice, and the like are easier to remove.

Antimicrobial active substances can be used in order to counteract microorganisms. A distinction is made here, in terms of the antimicrobial spectrum and mechanism of action, between bacteriostatics and bactericides, fungistatics and fungicides, Important substances from these groups are, for example, benzalkonium chlorides, alkylarylsulfonates, halogen phenols, and phenol mercuric acetate; these compounds can also be entirely dispensed.

In order to prevent undesirable changes to the washing and cleaning agents and/or to the treated textiles caused by the action of oxygen and other oxidative processes, the agents can contain antioxidants. This class of compounds includes, for example, substituted phenols, hydroquinones, catechols, and aromatic amines, as well as organic sulfides, polysulfides, dithiocarbamates, phosphites, and phosphonates.

Increased wearing comfort can result from the additional use of antistatic agents. Antistatic agents increase the surface conductivity and thus make possible improved dissipation of charges that have formed. External antistatic agents are usually substances having at least one hydrophilic molecule ligand and form a more or less hygroscopic film on the surfaces. These usually surface-active antistatic agents can be subdivided into nitrogen-containing (amines, amides, quaternary ammonium compounds), phosphorus-containing (phosphoric acid esters), and sulfur-containing antistatic agents (alkylsulfonates, alkyl sulfates). Lauryl (or stearyl) dimethylbenzylammonium chlorides are likewise suitable as antistatic agents for textiles or as an additive to washing agents, an avivage effect additionally being achieved.

For textile care and in order to improve textile properties, such as a softer “hand” (avivage) and decreased electrostatic charge (increased wearing comfort), conditioners can be used. The active substances in conditioner formulations are “esterquats,” quaternary ammonium compounds having two hydrophobic radicals such as, for example, distearyldimethylammonium chloride, although because of its insufficient biodegradability the latter is increasingly being replaced by quaternary ammonium compounds that contain ester groups in their hydrophobic radicals as defined break points for biodegradation.

These “esterquats” having improved biodegradability are obtainable, for example, by esterifying mixtures of methyl diethanolamine and/or triethanolamine with fatty acids and then quaternizing the reaction products in known fashion with alkylating agents. Dimethylolethylene urea is additionally suitable as a finish.

Silicone derivatives, for example, can be used in order to improve the water absorption capability and rewettability of the treated textiles and to facilitate ironing of the treated textiles. These additionally improve the rinsing behavior of the washing or cleaning agents as a result of their foam-inhibiting properties. Preferred silicone derivatives are, for example, polydialkyl or alkylarylsiloxanes in which the alkyl groups have one to five C atoms and are entirely or partly fluorinated. Preferred silicones are polydimethylsiloxanes, which optionally can be derivatized and are then aminofunctional or quaternized or have Si—OH, Si—H, and/or Si—Cl bonds. Additional preferred silicones are the polyalkylene-oxide-modified polysiloxanes, polysiloxanes that comprise, for example, polyethylene glycols, as well as the polyalkylene-oxide-modified dimethylpolysiloxanes.

Lastly, UV absorbers can also be used according to the present invention; these are absorbed onto the treated textiles and improve the light-fastness of the fibers. Compounds that exhibit these desired properties are, for example, the compounds that act by radiationless deactivation, and derivatives of benzophenone having substituents in the 2- and/or 4-position. Also suitable are substituted benzotriazoles, acrylates phenyl-substituted in the 3-position (cinnamic acid derivatives) optionally having cyano groups in the 2-position, salicylates, organic Ni complexes, and natural substances such as umbelliferone and endogenous urocanic acid.

Because of their fiber-protecting action, protein hydrolysates are additional active substances from the field of the washing and cleaning agents that are preferred in the context of the present invention. Protein hydrolysates are product mixtures obtained by the acid-, base-, or enzyme-catalyzed breakdown of proteins. Protein hydrolysates of both plant and animal origin can be used according to the present invention. Animal protein hydrolysates are, for example, elastin, collagen, keratin, silk, and milk protein hydrolysates, which can also be present in the form of salts. The use of protein hydrolysates of plant origin, soy, almond, rice, bean, potato, and wheat protein hydrolysates, is preferred according to the present invention. Although the use of protein hydrolysates is preferred, instead of them it is also optionally possible to use amino-acid mixtures obtained in different fashions, or individual amino acids such as, for example, arginine, lysine, histidine, or pyroglutamic acid. It is likewise possible to use derivatives of protein hydrolysates, for example, in the form of their fatty acid condensation products.

1. A washing- or cleaning-agent shaped element comprising compressed particulate material comprising a particulate surfactant granulate having a concentration of nonionic surfactants above 50 wt %, and at least 70 wt % of the particles of said surfactant granulate having a particle size below 1250 μm.

2. The washing- or cleaning-agent shaped element of claim 1 wherein the concentration of nonionic surfactants is above 90 wt %.

3. The washing- or cleaning-agent shaped element of claim 2 wherein the concentration of nonionic surfactants is above 80 wt %.

4. The washing- or cleaning-agent shaped element of claim 1 wherein at least 90 wt % of the particles of the surfactant granulate have a particle size below 1250 μm.

5. The washing- or cleaning-agent shaped element of claim 4 wherein at least 80 wt % of the particles of the surfactant granulate have a particle size below 1250 μm.

6. The washing- or cleaning-agent shaped element of claim 1 wherein at least 90 wt % of the particles of the surfactant granulate have a particle size between 100 μm and 1250 μm.

7. The washing- or cleaning-agent shaped element of claim 1 wherein the surfactant granulate contains 0.2 to 4 wt % of a silicate material.

8. The washing- or cleaning-agent shaped element of claim 7 wherein the surfactant granulate contains from 1 to 3 wt % of a silicate material.

9. The washing- or cleaning-agent shaped element of claim 1 wherein the surfactant granulate contains at least one nonionic surfactant of the general formula
R¹O[CH₂CH₂O]ₓCH₂CH(OH)R²
wherein R¹ is a linear or branched alkyl and/or alkenyl radical having 4 to 22 carbon atoms, R² is a linear or branched alkyl and/or alkenyl radical having 2 to 22 carbon atoms and x is from 1 to 90.

10. The washing- or cleaning-agent shaped element of claim 9 wherein x is from 10 to 30.

11. The washing- or cleaning-agent shaped element of claim 9 wherein x is from 40 to 80.

12. The washing- or cleaning-agent shaped element of claim 1 wherein the compressed particulate material further comprises at least one dye.

13. A surfactant granulate having a concentration of nonionic surfactants above 50 wt % wherein at least 70 wt % of the particles of the surfactant granulate have a particle size below 1250 μm.

14. The surfactant granulate of claim 13 wherein at least 75 wt % of the particles of the surfactant granulate have a particle size below 1250 μm.

15. The surfactant granulate of claim 13 wherein the percentage of particles of the surfactant granulate having a particle size below 1250 μm is above 90 wt %.

16. The surfactant granulate of claim 13 wherein at least 60 wt % of the particles have a particle size between 100 μm and 1250 μm.

17. The surfactant granulate of claim 13 wherein the surfactant granulate concentration is at least 80 wt %.

18. The surfactant granulate of claim 13 wherein the surfactant granulate has a concentration of nonionic surfactants above 90 wt %.

19. The surfactant granulate of claim 13 wherein the surfactant granulate contains from 0.2 to 4 wt % of a silicate material.

20. The surfactant granulate of claim 19 wherein the surfactant granulate contains from 1 to 3 wt % of a silicate material.
